(19) United States
(12) Patent Application Publication
(10) Pub. No.: US 2010/0250489 A1
(43) Pub. Date: Sep. 30, 2010

(54) Recording medium recording information copying program, information copying device, and information copying method

(75) Inventors: Takashi Akiyama, Kawasaki (JP); Kazuya Omura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,979

(22) Filed: Mar. 26, 2010

(30) Foreign Application Priority Data
Mar. 31, 2009 (JP) 2009-87593

(51) Int. Cl. G06F 17/30

(52) U.S. Cl. 707/610; 707/748; 707/E17.005; 707/E17.014; 707/758

(57) ABSTRACT

A non-transitory recording medium recording an information copying program is provided. The information copying program includes a sequence information computation procedure of, when an alteration process is executed on information stored at a copy source storing plural items of information, computing sequence information representing an ordinal rank of the altered information within records, which are stored at the copy source, by using information representing an altered location with respect to the records, and a copy destination reflection procedure of reflecting the alteration process upon information at a copy destination corresponding to the sequence information computed in the sequence information computation procedure.

### CROSS-REFERENCE TO RELATED APPLICATION(S)

This application is related to and claims priority to Japanese Patent Application No. 2009-87593, filed on Mar. 31, 2009, and incorporated herein by reference.

### BACKGROUND

1. Field

The embodiments discussed herein are directed to an information copying program, an information copying device, and an information copying method.

2. Description of the Related Art

RDB (Relational DataBase) in which records including plural items of information correlated with one another may be managed in the table format. NDB (Network DataBase) in which stored records may be managed together with information representing a hierarchical relation and information representing a relative sequence relation.

In the NDB, records are stored in such a manner that information representing a hierarchical relation is attached to each of the stored records. More specifically, as illustrated in FIG. 25, the NDB stores, in relation to a record “A1”, information representing that the record “A1” is a “parent record”. Thus, the NDB stores such a hierarchical relation that the record “A1” is information at a higher level than other records “A11” to “A13”.

The NDB stores, in relation to the other records “A11” to “A13” than the record “A1”, information representing that the records “A11” to “A13” are “child records”. Thus, the NDB stores such a hierarchical relation that each of the records “A11” to “A13” is information at a lower level than the records “A1”.

Further, the NDB stores, as information representing a relative sequence relation, a pointer that is information representing the record set next in sequence. For example, as illustrated in FIG. 25, the NDB stores a pointer indicating that “A12” is the record next to “A11”.

On the other hand, the RDB stores, as an absolute sequence relation, sequence relations among records by attaching numerical values indicating respective ordinal ranks to the stored records. For example, the RDB stores, as the sequence relation, an ordinal rank “1” in correspondence with the record “A11”.

As one of techniques for utilizing the NDB and the RDB, there is known a technique for converting records in the NDB to records in the RDB and copying (replicating) the former records in the RDB. When records in the NDB are converted to records in the RDB according to the known techniques, the sequence relations among the stored records in the RDB cannot be recognized in the RDB sometimes as illustrated in FIG. 26, because the sequence relations among the records are not stored in the NDB by using numerical values.

Conventionally, a method when records in the NDB are converted to records in the RDB, generates respective sequence numbers of the records in the NDB and storing the generated sequence numbers in the RDB together with the records (see, e.g., Japanese Unexamined Patent Application Publication No. 2004-259075 and No. 2000-267906). A copying (replication) device confirms the ordinal ranks of the records one by one to generate the sequence number of each record while following the pointer attached to each record in the NDB, and forms a copy (replica) of each record attached with the generated sequence number.

When the records stored in the NDB are altered (by, e.g., addition, update, and deletion) and the sequence relations among the records are changed, the copying device regenerates the sequence number of each record and forms a copy of each record attached with the regenerated sequence number again in order to update the sequence numbers of the records stored in the RDB.

### SUMMARY

It is an aspect of the embodiments discussed herein to provide a non-transitory recording medium recording an information copying program and method

The above aspects can be attained by an information copying program including a sequence information computation procedure of, when an alteration process is executed on information stored at a copy source storing plural items of information, computing sequence information representing an ordinal rank of the altered information within records, which are stored at the copy source, by using information representing an altered location with respect to the records; and a copy destination reflection procedure of reflecting the alteration process upon information at a copy destination corresponding to the sequence information computed in the sequence information computation procedure.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a copy forming device according to a first embodiment;

FIG. 2 illustrates processing executed by an initial extraction module according to a first embodiment;

FIG. 3 illustrates a sequence number generation module according to a first embodiment;

FIG. 4A illustrates processing of an application program;

FIG. 4B illustrates processing of the application program;

FIG. 5 illustrates a differential extraction module according to a first embodiment;

FIG. 6 illustrates a differential reflection module according to a first embodiment;

FIG. 7A illustrates processing in the copy forming device according to a first embodiment;

FIG. 7B illustrates processing in the copy forming device according to a first embodiment;

FIG. 7C illustrates processing in the copy forming device according to a first embodiment;

FIG. 7D illustrates processing in the copy forming device according to a first embodiment;

FIG. 8 illustrates the processing flow of initial extraction according to a first embodiment;

FIG. 9A illustrates an addition process according to a first embodiment;

FIG. 9B illustrates the addition process according to a first embodiment;

FIG. 10A illustrates an update process according to a first embodiment;

FIG. 10B illustrates the update process according to a first embodiment;

FIG. 11A illustrates a deletion process according to a first embodiment;

FIG. 11B illustrates the deletion process according to a first embodiment;

FIG. 12 illustrates the processing flow of the initial extraction according to a first embodiment;

FIG. 13 illustrates processing executed by the differential extraction module according to a first embodiment;

FIG. 14A illustrates a search process executed by the differential extraction module according to a first embodiment;

FIG. 14B illustrates an addition process executed by the differential extraction module according to a first embodiment;

FIG. 14C illustrates an update process executed by the differential extraction module according to a first embodiment;

FIG. 14D illustrates a deletion process executed by the differential extraction module according to a first embodiment;

FIG. 15 illustrates a direct search executed by the differential extraction module according to a first embodiment;

FIG. 16 illustrates the processing executed by the sequence number generation module according to a first embodiment;

FIG. 17 illustrates the processing executed by the differential reflection module according to a first embodiment;

FIG. 18A illustrates an addition process executed by the differential reflection module according to a first embodiment;

FIG. 18B illustrates an update process executed by the differential reflection module according to a first embodiment;

FIG. 18C illustrates a deletion process executed by the differential reflection module according to a first embodiment;

FIG. 19 illustrates a data structure according to a first embodiment;

FIG. 20 illustrates a management area of a parent record in a network database according to a first embodiment;

FIG. 21 illustrates a work area in each of the initial extraction module and the sequence number generation module according to a first embodiment;

FIG. 22 illustrates a work area in the differential extraction module according to a first embodiment;

FIG. 23 illustrates a relational database at a copy destination according to a first embodiment;

FIG. 24 illustrates a computer for executing an information copying program;

FIG. 25 illustrates a related art; and

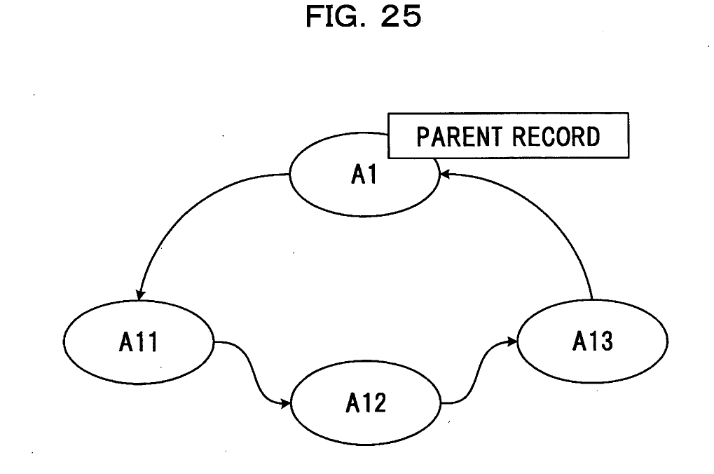

FIG. 26 illustrates a related art.

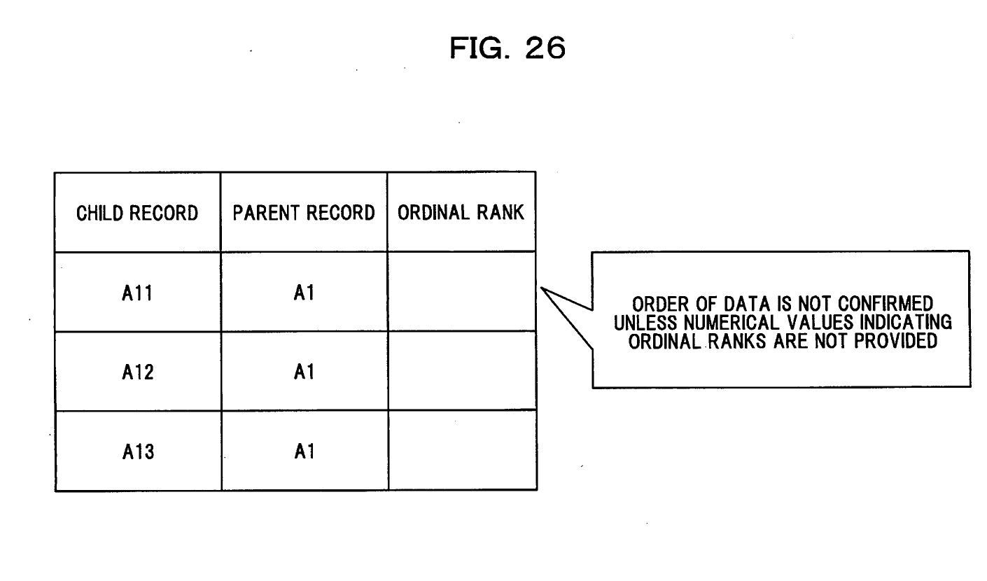

### DETAILED DESCRIPTION OF THE EMBODIMENTS

In a method of generating respective sequence numbers of records and storing the generated sequence numbers in the RDB together with the records, it may be required to form again a copy of each record attached with the generated sequence number when the records stored in the NDB are altered and the sequence relations among the records are changed. To that end, the ordinal ranks of the records are confirmed one by one to generate the sequence number of each record while following the pointer attached to each record in the NDB, and a copy of each record is formed again together with the generated sequence number. Accordingly, a method entails a large burden in a process of reflecting the alteration of the records stored in the NDB upon the RDB.

For converting records in the NDB to records in the RDB and copying the former records in the RDB, a method, after assigning numerical values indicating respective sequence relations to the records in the NDB, converting the records in the NDB to the records in the RDB and copying the former records in the RDB. With such a method when the records stored in the NDB are altered and the sequence relations among the records are changed, a copying device operates such that an application program requesting correction of the records in the NDB corrects the numerical values indicating the ordinal ranks of the records and reassigns numerical values indicating new sequence relations to the records.

Thus, with assigning numerical values indicating respective sequence relations to the records in the NDB, the application program requesting correction of the records in the NDB corrects the numerical values indicating the ordinal ranks of the records. Therefore, the application program needs to be modified so as to correct the numerical values indicating the ordinal ranks and to reassign numerical values indicating new sequence relations to the records in the NDB. This results in a large burden in a process of modifying the application program. Another problem is that, whenever the records stored in the NDB are altered and the sequence relations among the records are changed, the NDB has to be formed again by reassigning numerical values indicating the changed sequence relations to the records, respectively, whereby a large burden is required to reflect the alteration of the records stored in the NDB upon the RDB.

An aspect of an exemplary embodiment provides e an information copying program, an information copying device, and an information copying method, which can reflect alteration of records stored in the NDB upon the RDB without modifying an application program and forming an information copying program for the NDB again.

According to an embodiment, when an alteration process is executed on information at a copy source, sequence information representing an ordinal rank of altered information is computed and information at a copy destination is updated by using the computed sequence information.

Further, an embodiment reduces a burden required in a process of reflecting alternation of the records stored in the NDB on the RDB, and eliminates the necessity of modifying the application program and forming the information copying program for the NDB again.

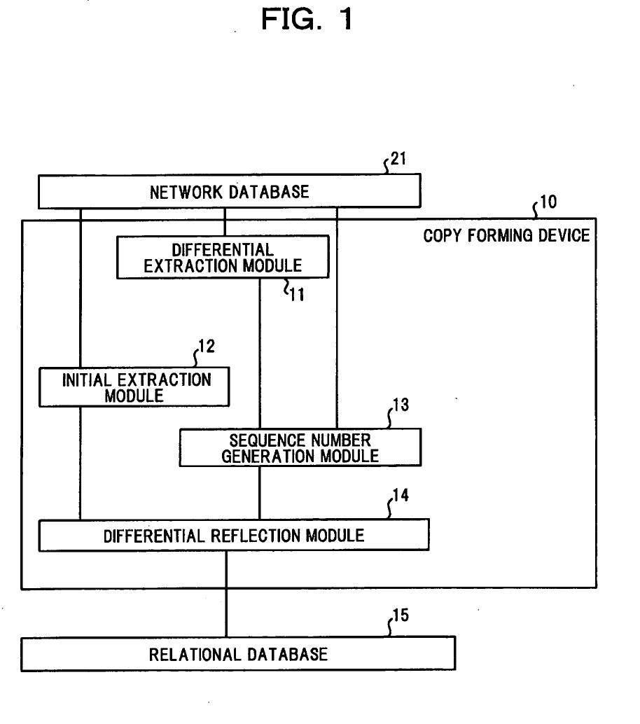

FIG. 1 illustrates the copy forming device according to a first embodiment. A copy forming device 10 includes a differential extraction module 11, an initial extraction module 12, a sequence number generation module 13, and a differential reflection module 14. The copy forming device 10 may be connected to a relational database 15 and a network database 21. The relational database 15 may be connected to the differential reflection module 14.

The network database 21 stores plural items of information by utilizing a network type data model. The network database 21 stores records by attaching information representing a hierarchical relation and a relative sequence relation to each item of the stored information. Further, the network database 21 executes various processes on the stored information in response to requests from an application program and notifies the type of the process to be executed to the differential extraction module 11.

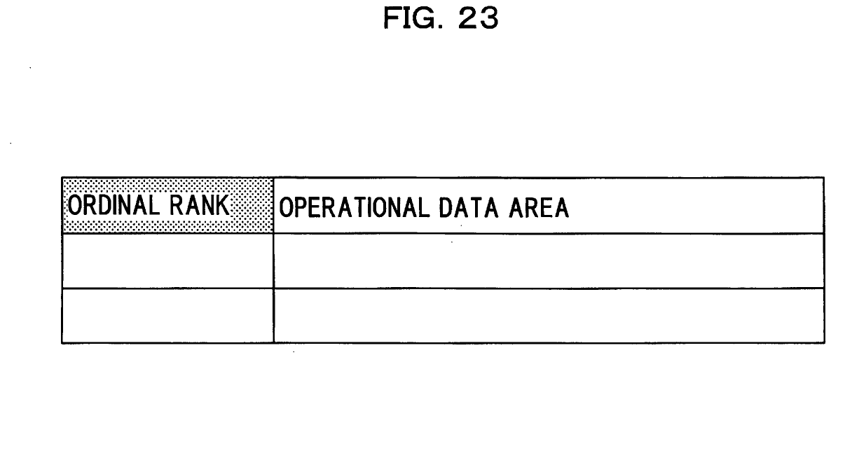

The relational database 15 stores plural items of information, which are correlated with one another in the table format. The relational database 15 has, as illustrated in FIG. 23, areas where numerical values indicating ordinal ranks are loaded and operational data areas where records are loaded. FIG. 23 illustrates the relational database at a copy destination according to a first embodiment.

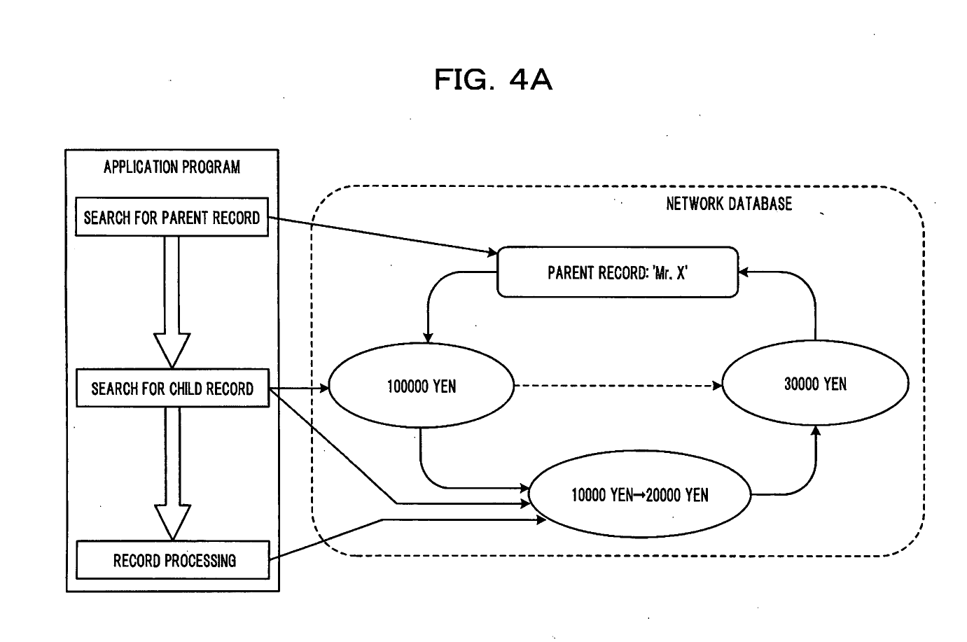

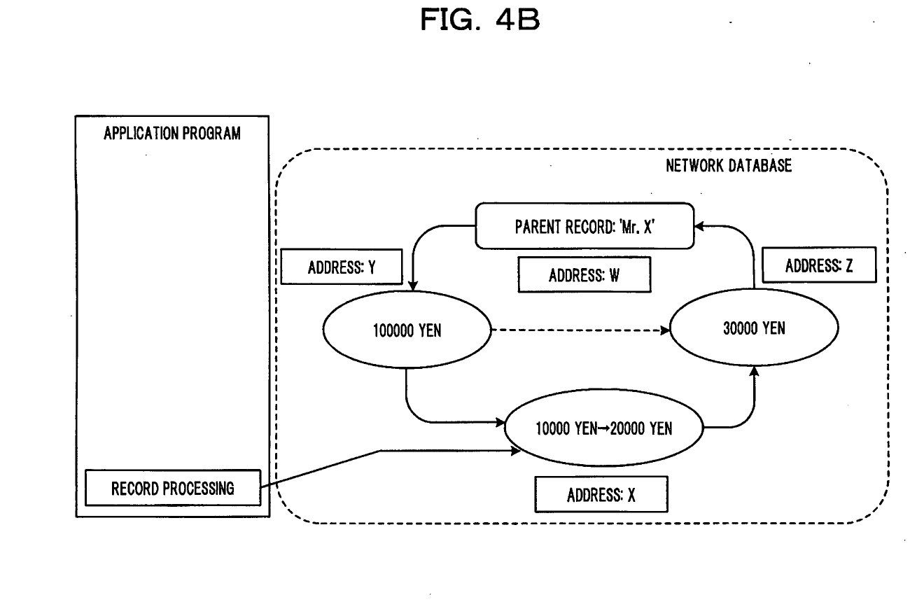

An application program for requesting various processes to the network database 21 is now described with reference to FIGS. 4A and 4B. FIG. 4A illustrates processing of the application program. FIG. 4B illustrates processing of the application program.

The application program requests various processes to be executed on the information stored in the network database 21. The application program requests an addition process, a deletion process, an update process and a search process to be executed on the information in the network type data model. Herein, the addition process may be defined as a process of newly adding information to be stored in the network database 21. The deletion process may be defined as a process of deleting the information stored in the network database 21. The update process may be defined as a process of updating the information stored in the network database 21. The search process may be defined as a process of searching for the information stored in the network database 21.

The application program specifies a child record, which becomes a target of any of the various processes, by using one of two methods. According to one method, as illustrated in FIG. 4A, the application program requests a search to be executed as per sequence indicated by a pointer that is attached to information of each record. For example, when a “second” child record belonging to a parent record “Mr. X” is “updated” to a value of “20000 yen”, the application program first requests the network database 21 to search for the parent record “Mr. X”.

The application program requests the network database 21 to search for the “second” child record belonging to the parent record “Mr. X” in sequence indicated by the pointers. The application program requests the network database 21 to update information of the selected “second” child record to a value of “20000 yen”.

According to FIG. 4B, an application program directly selects information that corresponds to a target of any of the various processes. The application program selects information that corresponds to a target of any of the various processes, by using address information representing a position where each record is stored. For example, when information corresponding to address information “X” is updated to “20000 yen”, the application program requests the network database 21 to directly select the information corresponding to the address information “X” and to update the selected information to a value of “20000 yen”, as illustrated in FIG. 4B.

The initial extraction module 12 searches for a parent record stored in the network database 21 to acquire information of the parent record. Further, the initial extraction module 12 acquires child records, which belong to the parent record having been searched for, in the order of pointers.

Whenever the initial extraction module 12 acquires each of the child records in the order of pointers, it counts the ordinal rank of the acquired child record and assigns a numerical value indicating the ordinal rank to the acquired child record. The initial extraction module 12 assigns, as a total child information number, the number of child records belonging to one parent record to the relevant parent record which is stored in the network database 21, i.e., at a copy source, and transmits the acquired information to the differential reflection module 14.

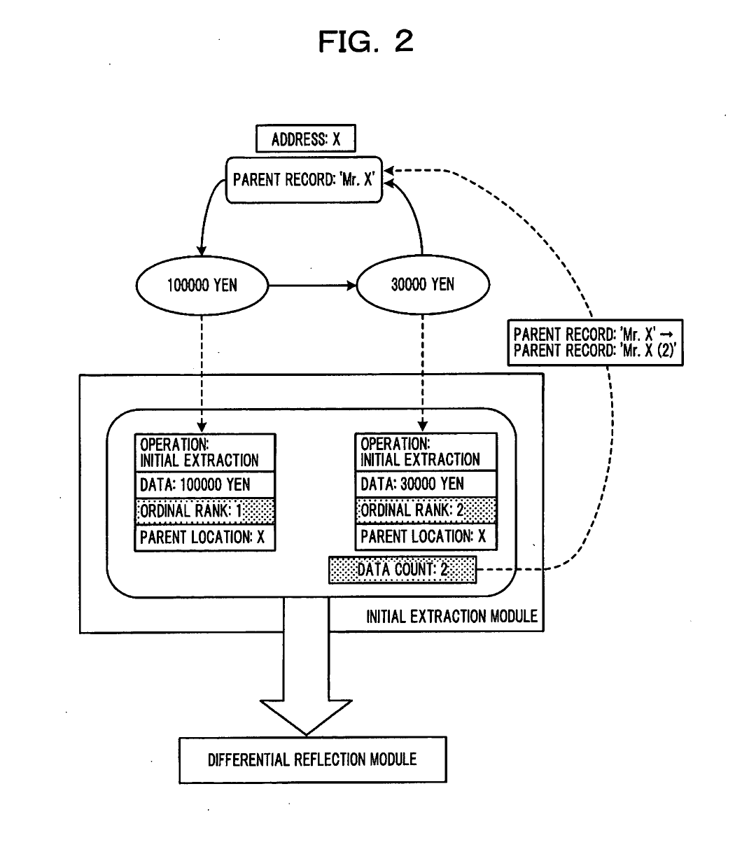

In the case illustrated in FIG. 2, for example, the initial extraction module 12 acquires information of the parent record “Mr. X”, and then counts the ordinal rank of the child record having information of “100000 yen” as “1” and the ordinal rank of the child record having information of “30000 yen” as “2”. Further, the initial extraction module 12 assigns respective numerical values indicating the ordinal ranks to the acquired child records and transmits the acquired child records to the differential reflection module 14.

The initial extraction module 12 attaches the number “2” of child records belonging to the parent record “Mr. X” to the information of the parent record “Mr. X” stored in the network database 21. FIG. 2 illustrates the processing executed by the initial extraction module according to a first embodiment.

When any of various alteration processes is executed on the record stored in the network database 21, the differential extraction module 11 acquires information representing the altered record. The differential extraction module 11 receives a process type, operational data, an operation location, and a parent location from the network database 21, and also receives the total child information number, which is recorded in the parent record, by using the parent location. The differential extraction module 11 transmits, as process information, both the received information and the received total child information number to the sequence number generation module 13.

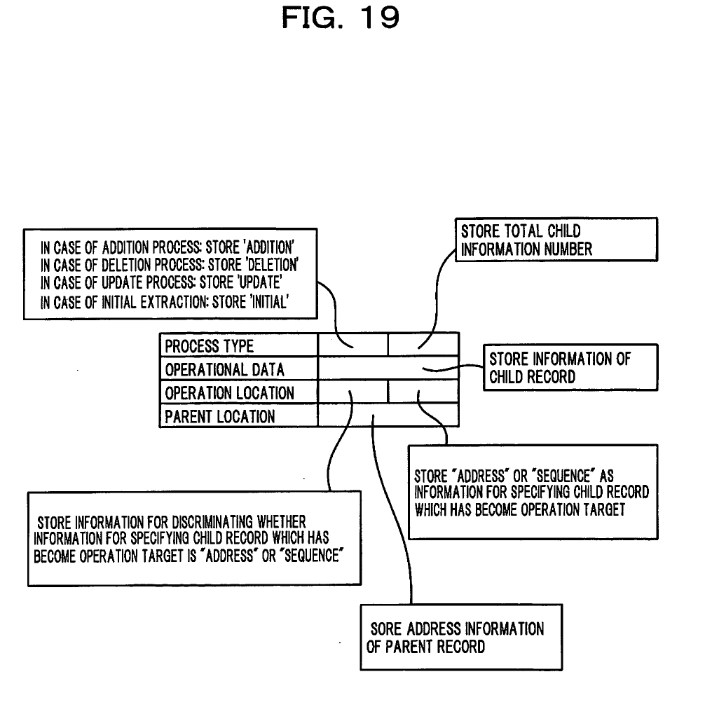

FIG. 19 illustrates a data structure according to a first embodiment. The process information includes respective items of information representing the process type, the operational data, the operation location, and the parent location. The differential extraction module 11 and the initial extraction module 12 load the relevant information as each item of the process information and transmit the stored information to the differential reflection module 14.

The term “process type” may be defined as the type (substance) of a process that is requested to the network database 21 from the application program. The differential extraction module 11 loads, as the process type, information representing any of “addition”, “update”, and “deletion”. The differential extraction module 11 loads the total child information number recorded in the parent record, which is made correspondent to the child record as a processing target, in association with the process type. The initial extraction module 12 loads “initial” as the process type.

The term “operational data” may be defined as the contents of the child record that has become a target of any of the various processes. The differential extraction module 11 loads the contents of the child record as the target of any of the various processes. The term “operation location” may be defined as information necessary for specifying data that has become a target of any of the various processes.

The differential extraction module 11 loads, as the operation location, the ordinal rank (sequence number) or the address information of the child record that becomes the target of any of the various processes. The term “parent location” may be defined as information necessary for specifying the parent record having data that has become a target of any of the various processes. The differential extraction module 11 loads, as the parent location, the address information of the parent record.

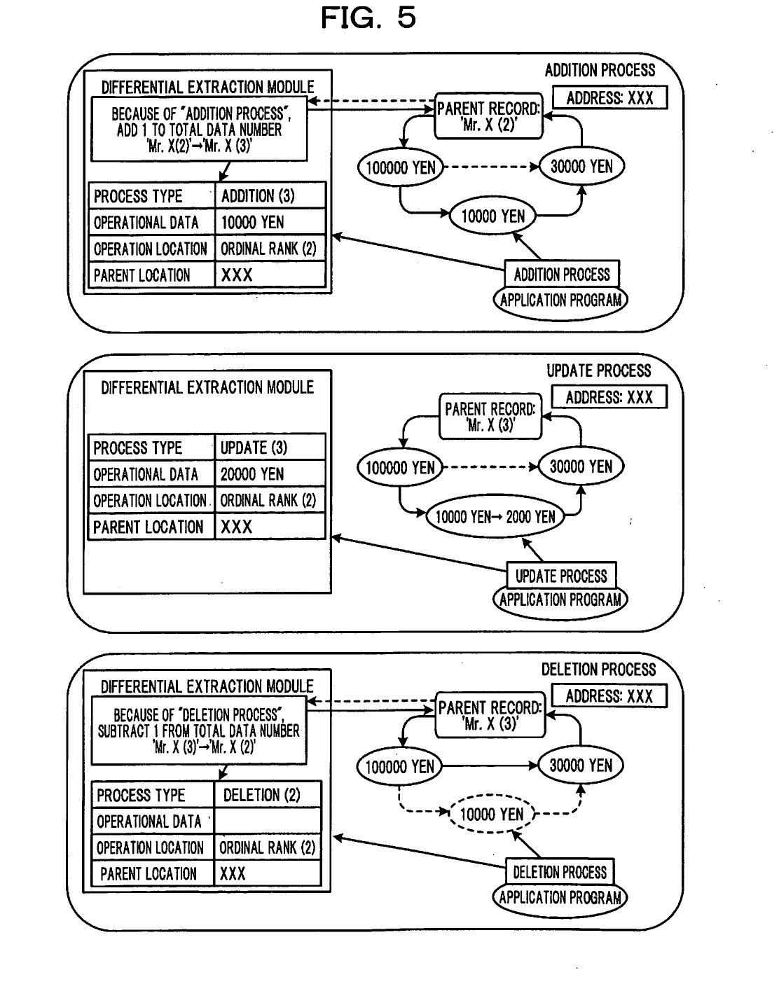

FIG. 5 illustrates the differential extraction module according to a first embodiment. When the application program requests the network database 21 to execute the addition process of information, the differential extraction module 11 loads the process type, the operational data, the operation location, and the parent location as respective items of the process information by using the information received from the network database 21.

The differential extraction module 11 acquires the total child information number from the parent record that is specified by using the parent location, and loads a value resulting from adding “1” to the acquired total child information number, as a new total child information number, in the same parent record. Further, the differential extraction module 11 loads the new total child information number in the process information.

In the case illustrated in FIG. 5, the differential extraction module 11 loads “addition” as the process type, an address “XXX” as the parent location, an ordinal rank “2” as the operation location, and “10000 yen” as the operational data. In order to reflect the number of child records which has increased with the addition process, the differential extraction module 11 alters the total child information number “2”, which has been attached to the parent record “Mr. X (2)”, to “3”. Further, the differential extraction module 11 loads the altered total child information number “3” in association with the process type.

When the application program requests the network database 21 to execute the update process of information, the differential extraction module 11 loads the process type, the operational data, the operation location, and the parent location as respective items of the process information by using the information received from the network database 21.

In the case illustrated in FIG. 5, the differential extraction module 11 loads “update” as the process type, and “XXX” as the parent location. Further, the differential extraction module 11 loads an ordinal rank “2” as the operation location, and “20000 yen” as the operational data. Because the number of child records belonging to the parent record is not changed by the update process, the differential extraction module 11 neither alters the total child information number held in the parent record, nor loads a new total child information number in association with the process type.

When the application program requests the network database 21 to execute the deletion process of information, the differential extraction module 11 loads the process type, the operational data, the operation location, and the parent location as respective items of the process information by using the information received from the network database 21. The differential extraction module 11 acquires the total child information number from the parent record that is specified by using the parent location, and loads a value resulting from subtracting “1” from the acquired total child information number, as a new total child information number, in the same parent record. Further, the differential extraction module 11 loads the new total child information number in the process information.

In the case illustrated in FIG. 5, the differential extraction module 11 loads “deletion” as the process type, “XXX” as the parent location, and an ordinal rank “2” as the operation location. When the application program executes the deletion process, the differential extraction module 11 does not load any information as the operational data. Then, in order to reflect the number of child records which has decreased with the deletion process, the differential extraction module 11 alters the total child information number “3”, which has been attached to the parent record “Mr. X (3)”, to “2”. Further, the differential extraction module 11 loads the altered total child information number “2” in association with the process type.

When the differential extraction module 11 has formed the process information, it transmits the process information containing the respective items of the stored information to the sequence number generation module 13. In the case where the application program selects the child record as a target of any of the various processes by using address information instead of the sequence, the differential extraction module 11 loads the address information instead of the sequence as the operation location.

The sequence number generation module 13 generates sequence information representing the ordinal rank of the altered record based on the information acquired by the differential extraction module 11. The sequence number generation module 13 confirms the operation location from the process information received from the differential extraction module 11. When the address information is loaded as the information representing the operation location instead of the numerical value indicating the ordinal rank, the sequence number generation module 13 searches for the record, which has become the target of the alteration process, by using the address information. Further, the sequence number generation module 13 finds at what ordinal rank (position) the child record as the target of the alteration process resides when the search is executed from a predetermined record in the order of pointers.

The sequence number generation module 13 searches for the parent record, which is stored in the network database 21, by using the address information loaded as the parent location. The sequence number generation module 13 searches for the child record having the address information, which is loaded as the operation location, in the order of pointers while counting the number of child records.

When the sequence number generation module 13 recognizes the child record stored at an address that matches with the address information loaded as the operation location, it acquires the counted number of child records as the recognized ordinal rank of the child record. Thereafter, the sequence number generation module 13 erases the address information that has been loaded as the operation location, and loads a numerical value indicating the acquired ordinal rank.

The application program utilizes the ordinal rank of the child record or the address information of the child record to execute a method of selecting the child record that becomes the target of any of the various processes. When the application program selects the child record by using the address information, the sequence number generation module 13 alters the address information to a numerical value indicating the ordinal rank.

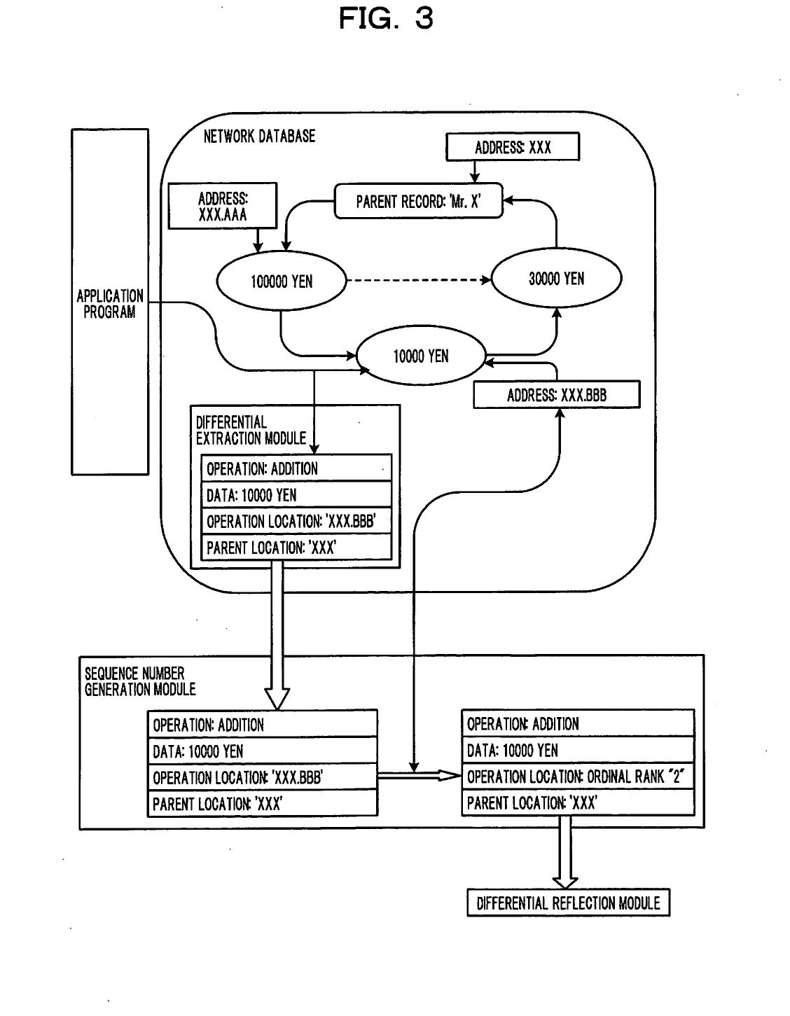

In the case illustrated in FIG. 3, for example, the sequence number generation module 13 searches for the parent record “Mr. X”, which is stored at the address “XXX”, in the network database 21. The sequence number generation module 13 searches for the child record having an address “XXX.BBB” in the order of pointers starting from the parent record “Mr. X” while counting the number of child records.

In the case illustrated in FIG. 3, because the child record having the address “XXX.BBB” is the “second” child record, the sequence number generation module 13 recognizes that the ordinal rank of the child record having the address “XXX.BBB” is the “second”. The sequence number generation module 13 erases the address information that has been loaded as the operation location in the process information, and loads numerical information, i.e., the ordinal rank “2”, instead. FIG. 3 illustrates the sequence number generation module according to a first embodiment.

When the information acquired by the differential extraction module 11 represents the ordinal rank of the child record, the sequence number generation module 13 utilizes the information acquired by the differential extraction module 11 as it may be. Stated another way, when the information loaded as the operation location is a numerical value indicating the ordinal rank, the sequence number generation module 13 does not alter the information loaded as the operation location.

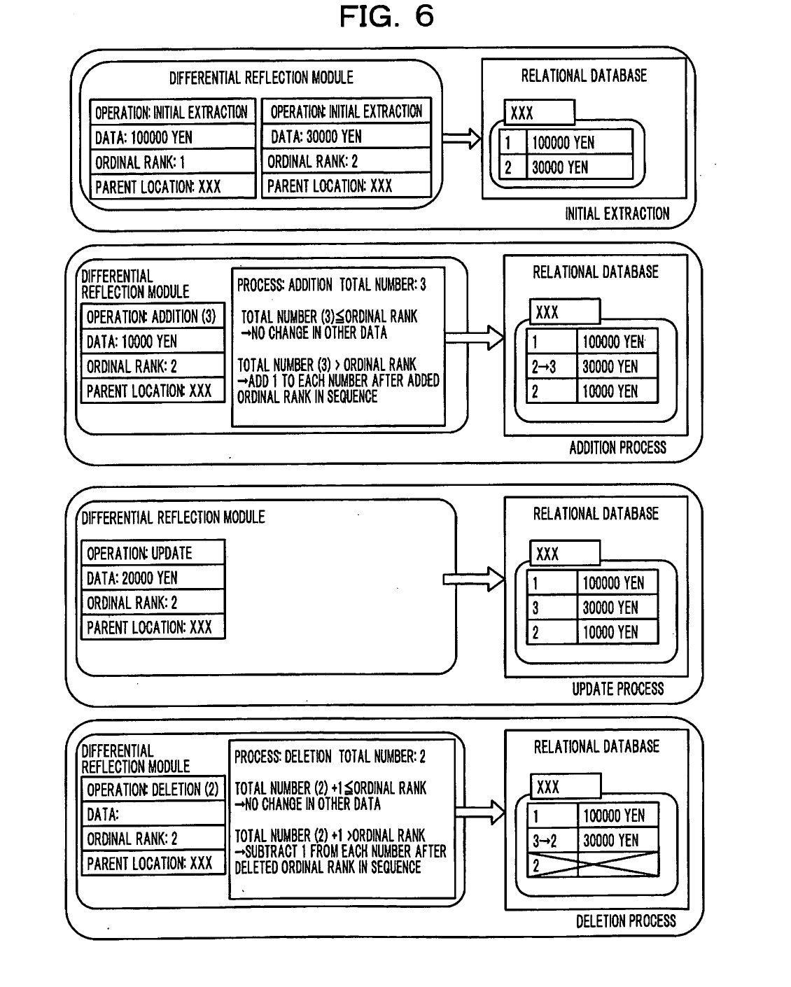

In accordance with the sequence information generated by the sequence number generation module 13, the differential reflection module 14 reflects, upon the relational database 15, the various alteration processes that have been executed on the information stored in the network database 21. The differential reflection module 14 reflects each record received from the sequence number generation module 13 or the initial extraction module 12 upon the relational database 15. The differential reflection module 14 selects and updates one or more among the records stored in the relational database 15, which are to be updated. FIG. 6 illustrates the differential reflection module according to a first embodiment.

When the information loaded as the process type in the received process information represents the initial extraction, the differential reflection module 14 causes the relational database 15 to store new information by using the received process information. In the case illustrated in FIG. 6, the differential reflection module 14 causes the relational database 15 to store the child record “100000 yen”, which is correlated with the parent record stored in the parent location “XXX”, while the ordinal rank “1” is attached thereto as the operation location contained in the process information. Further, the differential reflection module 14 causes the relational database 15 to store the child record “30000 yen”, which is correlated with the parent record stored in the parent location “XXX”, while the ordinal rank “2” is attached thereto.

When the information loaded as the process type in the received process information represents “addition”, the differential reflection module 14 alters the information stored in the relational database 15 by using the received process information. The differential reflection module 14 causes the relational database 15 to store new information by using respective items of the process information which are loaded as the process type, the operational data, the parent location, and the operation location.

The differential reflection module 14 makes a correction to increase the sequence number of the record stored in the relational database 15 by using the information loaded as the operation location.

The differential reflection module 14 specifies information to be corrected from among the plural items of information stored in the relational database 15 by using the total child information number that is loaded in association with the process type, and corrects the numerical value indicating the ordinal rank of the specified information.

For example, when one child record is newly added as a sixth child record to the parent record having five child records, the ordinal ranks of the existing five child records are not altered. Therefore, the differential reflection module 14 does not correct the ordinal ranks of the child records other than the added child record. However, when one child record is newly added as a third child record to the parent record having five child records, the differential reflection module 14 has to correct the ordinal ranks of three child records which are originally located in the third to fifth ranks.

By using the total child information number loaded in association with the process type and the ordinal rank of the child record loaded as the operation location, the differential reflection module 14 determines whether the ordinal rank of the added child record is the last among the child records belonging to the parent record. More specifically, when the number of ordinal rank loaded as the operation location in the process information is equal to or larger than the total child information number loaded in association with the process type, the differential reflection module 14 executes only the addition of the relevant child record and does not execute any correction of the other data stored in the relational database 15.

When the number of ordinal rank loaded as the operation location in the process information is smaller than the total child information number loaded in association with the process type, the differential reflection module 14 adds 1 to each of numerical values indicating the ordinal ranks, which are equal to or larger than the numerical value loaded as the operation location, among the data (information) of the child records stored in the relational database 15.

In FIG. 6, the differential reflection module 14 first recognizes a table of child records belonging to the parent record at a parent address that is loaded as the parent location. Because the total child information number loaded in association with the process type is “3” and the ordinal rank loaded as the operation location is “2”, the differential reflection module 14 then corrects the ordinal ranks of the child records having the original ordinal ranks of “2” or more.

In the case illustrated in FIG. 6, the differential reflection module 14 adds 1 to each of the ordinal ranks of the child records which are assigned with “2” or more as numerical values indicating the ordinal ranks, and newly adds information of “10000 yen” having the ordinal rank of “2”

When the information loaded as the process type in the received process information represents “update”, the differential reflection module 14 alters the information stored in the relational database 15 by using the received process information. The differential reflection module 14 updates the information stored in the relational database 15 by using respective items of the process information which are loaded as the operation location, the operational data, and the parent location.

In FIG. 6, the ordinal rank of the information loaded as the operation location is “2”, the information loaded as the operational data is “20000 yen”, and the information loaded as the parent location is “XXX”. Accordingly, the differential reflection module 14 corrects the information corresponding to the sequence number (ordinal rank) “2”, which is contained in the table of the child records each having the parent location “XXX”, among the data (information) stored in the relational database 15, to “20000 yen”.

When the information loaded as the process type in the received process information represents “deletion”, the differential reflection module 14 alters the information stored in the relational database 15 by using the received process information. The differential reflection module 14 deletes the information stored in the relational database 15 by using respective items of the process information which are loaded as the process type, the operational data, the parent location, and the operation location.

The differential reflection module 14 makes a correction to decrease the sequence number of the record stored in the relational database 15 by using the information loaded as the operation location.

The differential reflection module 14 specifies information to be corrected from among the plural items of information stored in the relational database 15 by using the total child information number that is loaded in association with the process type, and corrects the numerical value indicating the ordinal rank of the specified information.

For example, when the fifth child record is deleted from the parent record having five child records, the ordinal ranks of the other four child records are not altered. Therefore, the differential reflection module 14 is not required to correct the information of the child records other than the deleted child record. However, when the second child record is deleted from the parent record having five child records, the differential reflection module 14 has to correct the ordinal ranks of three child records which are originally located in the third to fifth ranks.

By using the total child information number loaded in association with the process type and the ordinal rank of the child record loaded as the operation location, the differential reflection module 14 determines whether the ordinal rank of the deleted child record is the last among the child records belonging to the parent record.

When the number of ordinal rank loaded as the operation location in the process information is equal to or larger than a value resulting from adding 1 to the total child information number loaded in association with the process type, the differential reflection module 14 executes only the deletion of the relevant child record and does not execute any correction of the other data stored in the relational database 15.

When the number of ordinal rank loaded as the operation location in the process information is smaller than the value resulting from adding 1 to the total child information number loaded in association with the process type, the differential reflection module 14 subtracts 1 from each of numerical values indicating the ordinal ranks, which are larger than the numerical value loaded as the operation location, among the data (information) of the child records stored in the relational database 15.

In the case illustrated in FIG. 6, the differential reflection module 14 first recognizes a table of child records belonging to the parent record stored at a parent address that is loaded as the parent location. Because the ordinal rank “2” loaded as the operation location is smaller than the value resulting from adding 1 to the total child information number “2” loaded in association with the process type, the differential reflection module 14 then corrects the ordinal ranks of the child records having the original ordinal ranks of “2” or more. More specifically, in the case illustrated in FIG. 6, the differential reflection module 14 subtracts 1 from each of the ordinal ranks of the child records which are assigned with “2” or more as numerical values indicating the ordinal ranks, and deletes the data loaded corresponding to “2” that has been assigned as the numerical value indicating the ordinal rank.

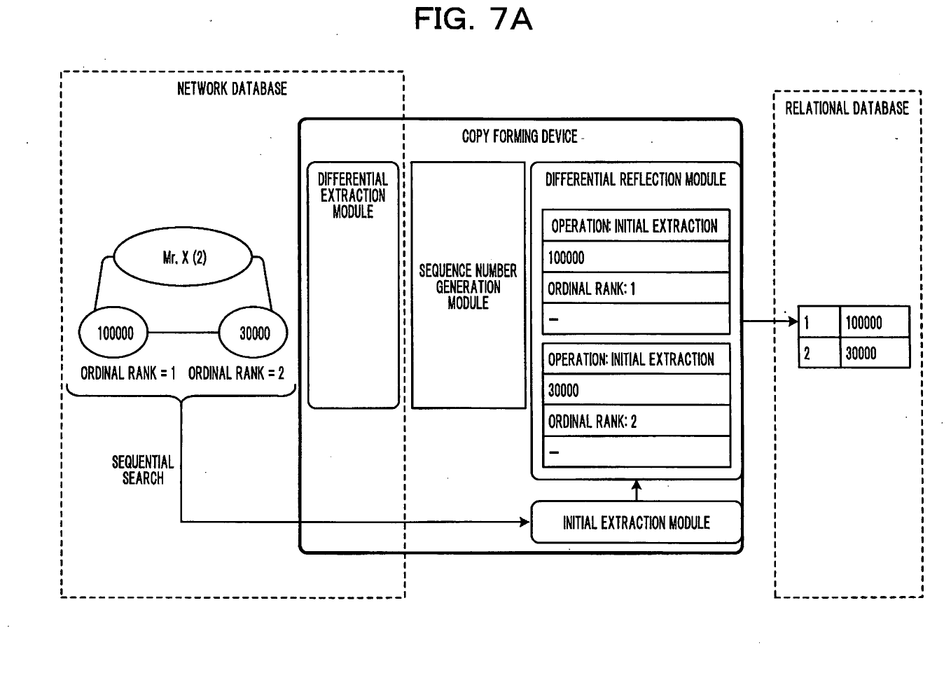

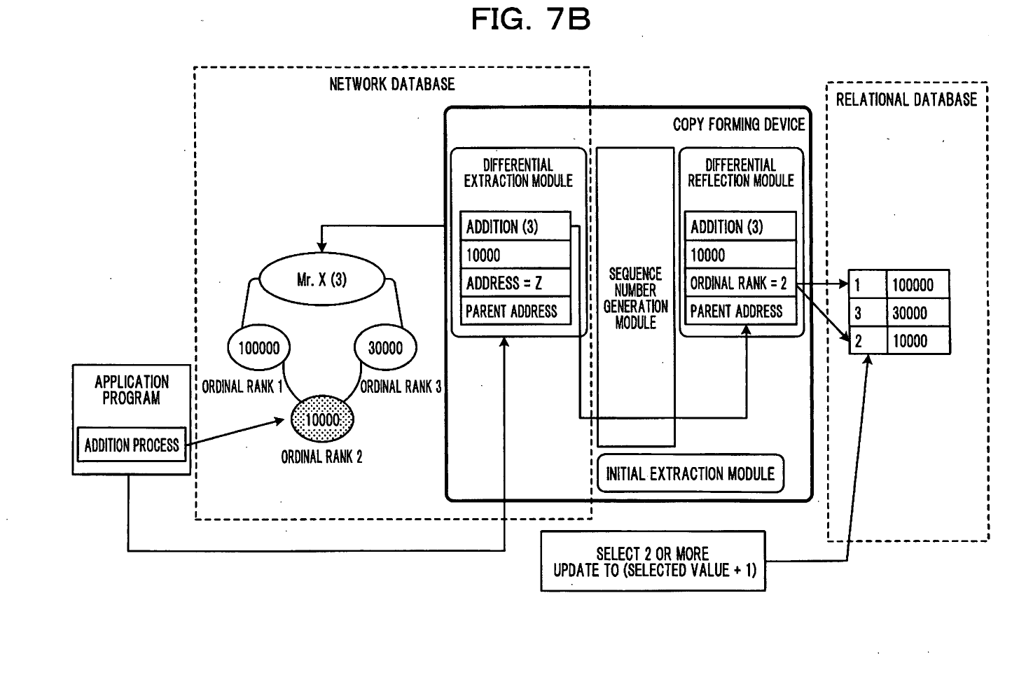

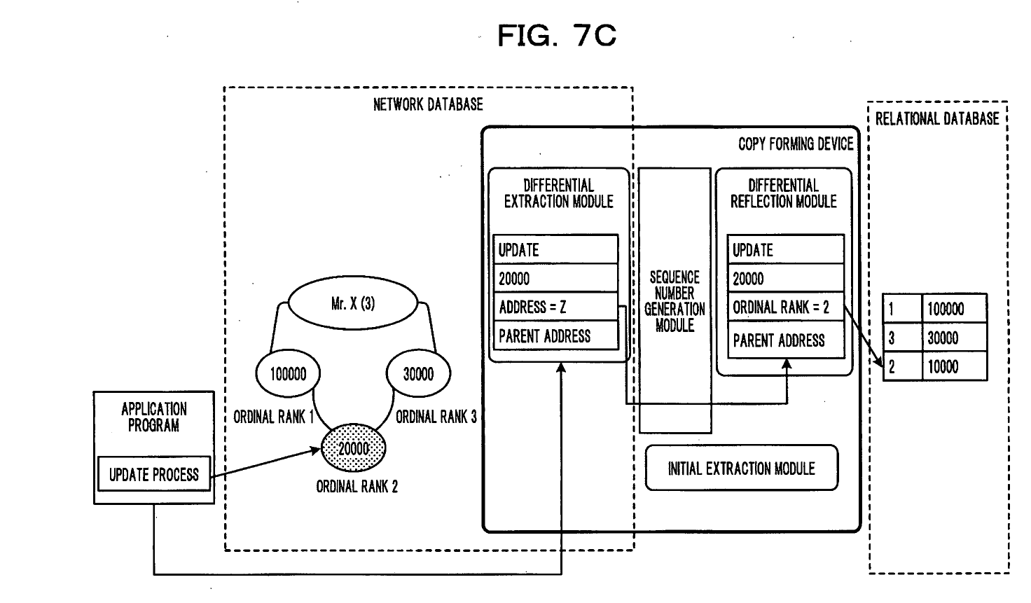

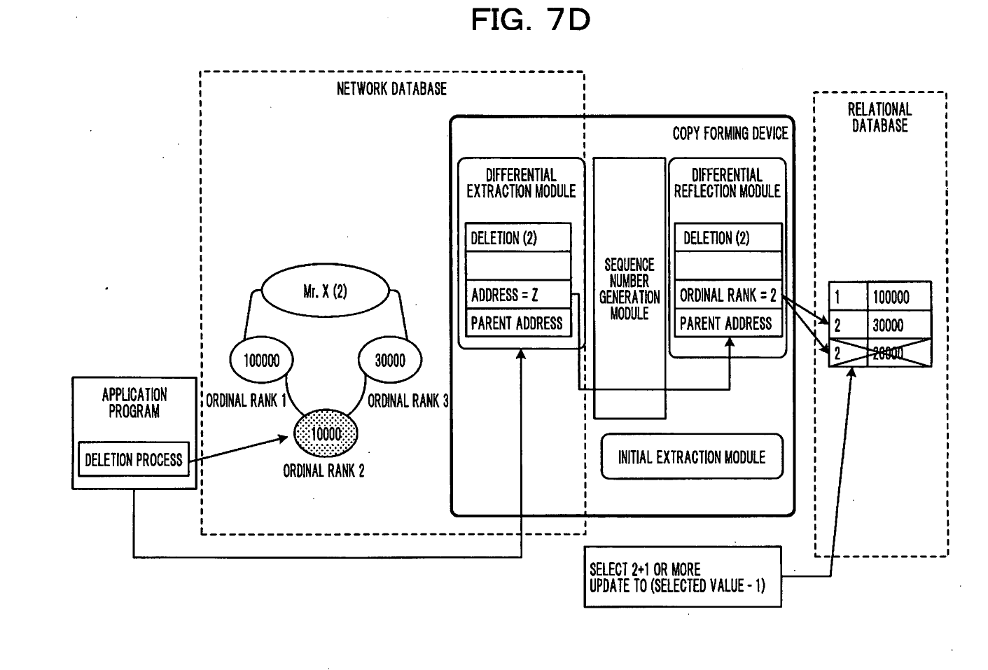

The following description refers to FIG. 7A, about the processing flow of the initial extraction executed in the copy forming device 10 when a first copy is performed from the network database 21 to the relational database 15. FIG. 7A illustrates the processing flow in the copy forming device according to a first embodiment.

The initial extraction module 12 searches for the parent record stored in the network database 21 and further searches for the child records belonging to the relevant parent record in the order of pointers to acquire the information of each of those child records. The initial extraction module 12 assigns a numerical value indicating the ordinal rank to the acquired information of each child record and transmits the assigned numerical value to the differential reflection module 14. The differential reflection module 14 causes the relational database 15 to store the received information.

A processing to reflect a differential upon the relational database 15 by the copy forming device 10 will be described with reference to FIG. 7B in connection the case where the application program requests a process of adding a child record to the network database 21. FIG. 7B illustrates the processing flow in the copy forming device according to a first embodiment.

The differential extraction module 11 receives the process type from the network database 21 and recognizes that the process to be executed is the addition process. The differential extraction module 11 acquires and updates the total child information number held in the parent record including the added child record. Further, the differential extraction module 11 forms process information from the total child information number and the process type, etc. received from the network database 21, and transmits the formed process information to the sequence number generation module 13.

The sequence number generation module 13 determines whether information loaded as the operation location in the process information is address information. If it may be address information, the sequence number generation module 13 searches the network database 21 and changes the address information loaded as the operation location to a numerical value indicating the corresponding ordinal rank. Thereafter, the sequence number generation module 13 transmits the process information to the differential reflection module 14. The differential reflection module 14 reflects the addition process upon the information stored in the relational database 15 by using the received process information.

Processing to reflect a differential upon the relational database 15 by the copy forming device 10 will be described below with reference to FIG. 7C in connection the case where the application program requests a process of updating a child record to the network database 21. FIG. 7C illustrates the processing flow in the copy forming device according to a first embodiment.

The differential extraction module 11 receives the process type from the network database 21 and recognizes that the process to be executed is the update process. The differential extraction module 11 forms process information from the process type, etc. received from the network database 21 and transmits the formed process information to the sequence number generation module 13.

The sequence number generation module 13 determines whether information loaded as the operation location in the process information is address information. If it may be address information, the sequence number generation module 13 searches the network database 21 and changes the address information loaded as the operation location to a numerical value indicating the corresponding ordinal rank. Thereafter, the sequence number generation module 13 transmits the process information to the differential reflection module 14. The differential reflection module 14 reflects the update process upon the information stored in the relational database 15 by using the received process information.

Processing to reflect a differential upon the relational database 15 by the copy forming device 10 will be described below with reference to FIG. 7D in connection the case where the application program requests a process of deleting a child record to the network database 21. FIG. 7D illustrates the processing flow in the copy forming device according to a first embodiment.

The differential extraction module 11 receives the process type from the network database 21 and recognizes that the process to be executed is the deletion process. The differential extraction module 11 acquires and updates the total child information number held in the parent record including the deleted child record. Further, the differential extraction module 11 forms process information from the total child information number and the process type, etc. received from the network database 21 and transmits the formed process information to the sequence number generation module 13.

The sequence number generation module 13 determines whether information loaded as the operation location in the process information is address information. If it may be address information, the sequence number generation module 13 searches the network database 21 and changes the address information loaded as the operation location to a numerical value indicating the corresponding ordinal rank. Thereafter, the sequence number generation module 13 transmits the process information to the differential reflection module 14. The differential reflection module 14 reflects the deletion process upon the information stored in the relational database 15 by using the received process information.

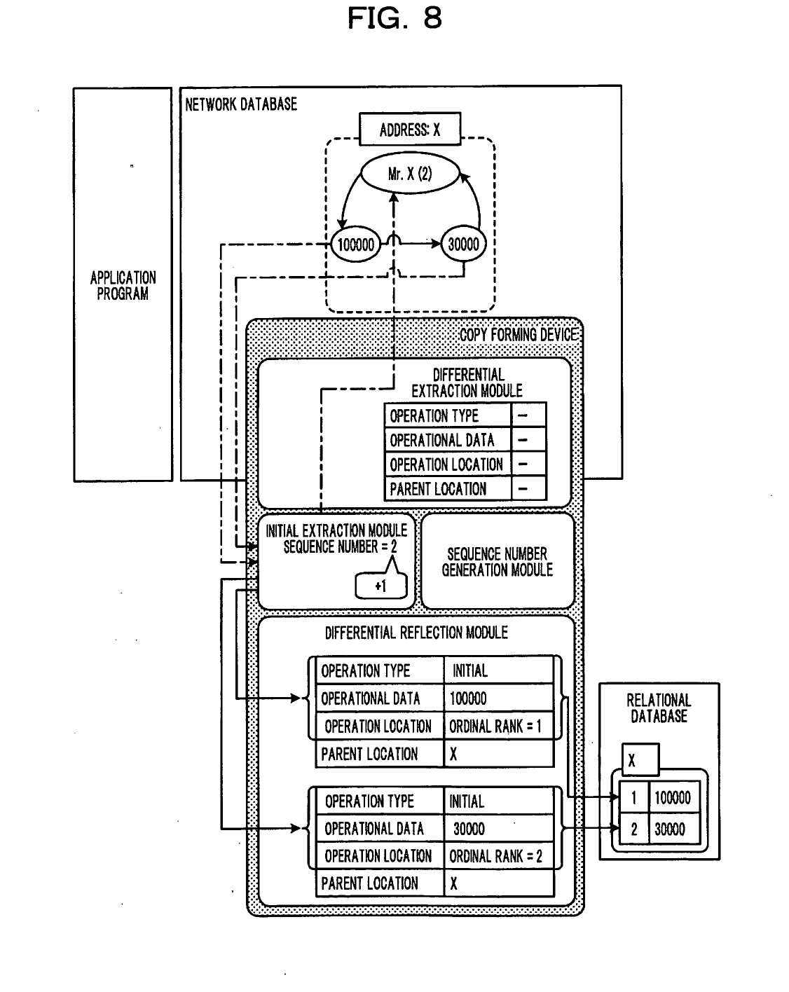

The processing executed in the copy forming device 10 will be described in more detail below with reference to FIGS. 8 to 11B. The initial extraction executed in the copy forming device 10 is first described with reference to FIG. 8. FIG. 8 illustrates the processing flow of the initial extraction according to a first embodiment.

The initial extraction module 12 acquires data to be stored in the network database 21. In the case illustrated in FIG. 8, the initial extraction module 12 acquires information “Mr. X” of the parent record and further acquires a first child record “100000” which is indicated by a pointer from the parent record “Mr. X”.

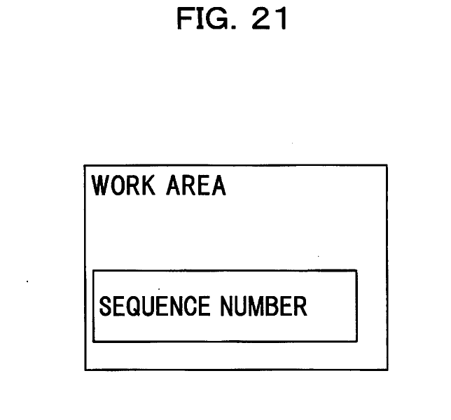

Here, the initial extraction module 12 forms process information in which “initial extraction” is loaded as the operation (processing) type, “100000” is loaded as the operational data, an ordinal rank “1” is loaded as the operation location, and “X” is loaded as the parent location. Further, the initial extraction module 12 loads a child information number “1” in a work area illustrated in FIG. 21. FIG. 21 illustrates a work area in each of the initial extraction module and the sequence number generation module according to a first embodiment.

The initial extraction module 12 acquires the second child record “30000” which is indicated by a pointer from a first child record “100000”. Here, the initial extraction module 12 forms process information in which “initial extraction” is loaded as the operation type, “30000” is loaded as the operational data, an ordinal rank “2” is loaded as the operation location, and “X” is loaded as the parent location. Further, the initial extraction module 12 loads a child information number “2” in the work area. Because data indicated by a pointer from the second child record “30000” is the parent record “Mr. X”, the initial extraction module 12 then brings the acquisition of the child records to an end and transmits the formed process information to the differential reflection module 14.

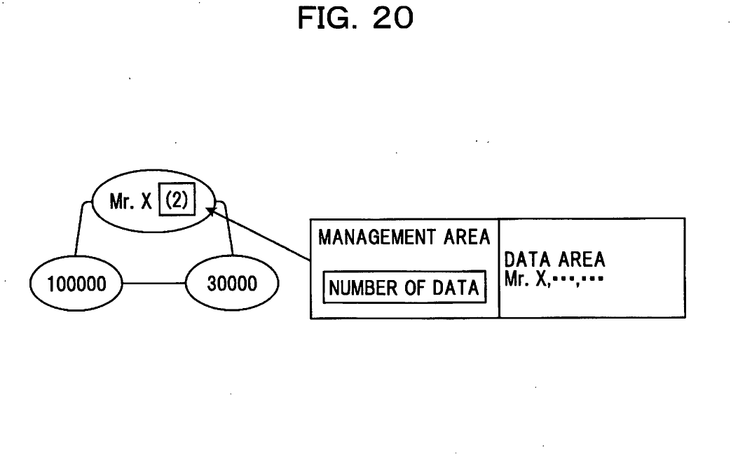

In addition, the initial extraction module 12 requests the network database 21 to add, as the total child information number, a child information number “2” loaded in the work area to the parent record “Mr. X”. The initial extraction module 12 requests the network database 21 to record the total child information number in a management area of the parent record “Mr. X”, which is illustrated in FIG. 20. FIG. 20 illustrates the management area of the parent record in the network database according to a first embodiment.

In the case illustrated in FIG. 8, the initial extraction module 12 requests the network database 21 to record the total child information number “2” in the management area of the parent record “Mr. X”.

The differential reflection module 14 receives the process information from the initial extraction module 12 and forms a copy in the relational database 15 based on the received process information. In the case illustrated in FIG. 8, the differential reflection module 14 causes the relational database 15 to store both information “100000” assigned with a numerical value “1” indicating the ordinal rank and information “30000” assigned with a numerical value “2” indicating the ordinal rank.

The differential reflection module 14 prepares SQL and transmits it to the relational database 15. In the case illustrated in FIG. 8, the differential reflection module 14 causes the relational database 15 to store the information “100000” assigned with the numerical value “1” indicating the ordinal rank by using the SQL command “LOAD”. The differential reflection module 14 causes the relational database 15 to store the information “30000” assigned with the numerical value “2” indicating the ordinal rank by using the SQL command “LOAD”.

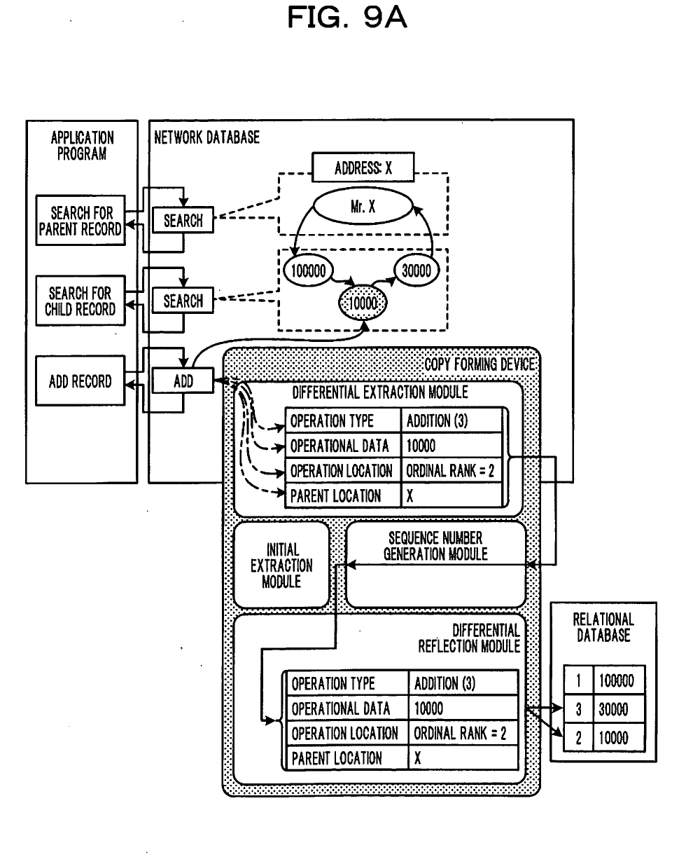

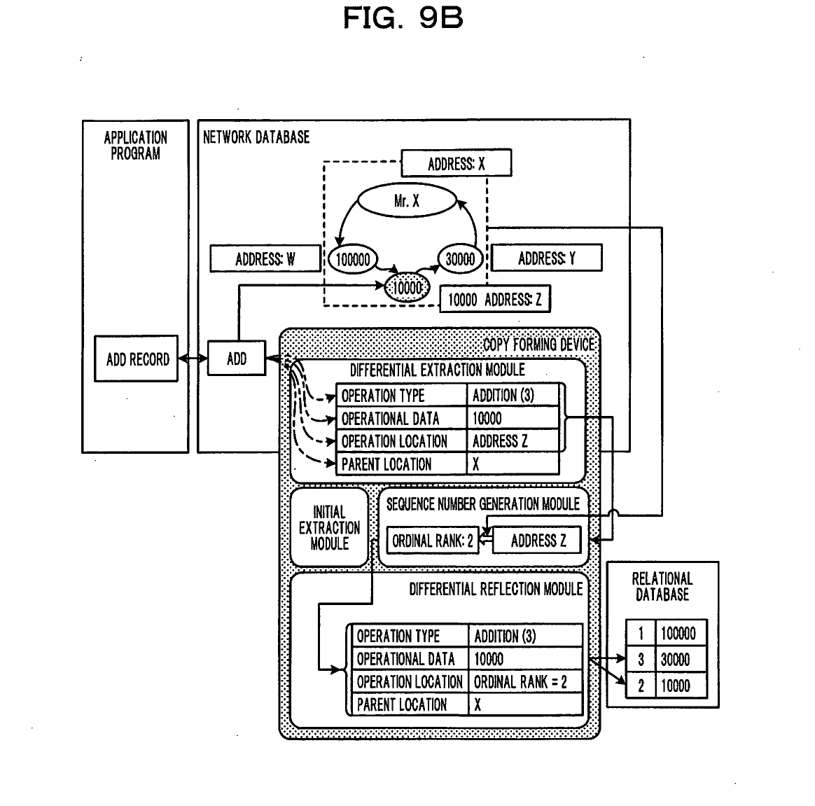

The addition process executed in the copy forming device 10 will be described in more detail below with reference to FIGS. 9A and 9B. FIG. 9A illustrates the addition process according to a first embodiment. FIG. 9B illustrates the addition process according to a first embodiment.

The addition process executed in the copy forming device 10 is described with reference to FIG. 9A. The application program requests the network database 21 to search for the parent record. The network database 21 searches for the parent record and notifies the differential extraction module 11 of the fact that it may be searching for the parent record. The differential extraction module 11 recognizes the search process for the parent record, and further loads the address “X” of the parent record as the parent location and “0” as the operation location.

The application program requests the network database 21 to search for the child record. The network database 21 searches for each of the child records in the order of pointers and notifies the presence of the child record to the differential extraction module 11 whenever each child record is recognized. Upon receiving the notification, the differential extraction module 11 adds 1 to the numerical value, which is loaded as the operation location and which indicates the ordinal rank, whenever the notification is received from the network database 21.

The application program requests the network database 21 to add a child record. The network database 21 executes the addition of the child record and notifies information “10000” of the added child record to the differential extraction module 11.

The differential extraction module 11 recognizes the execution of the addition process for the child record and adds 1 to the numerical value, which is loaded as the operation location and which indicates the ordinal rank. Accordingly, the differential extraction module 11 loads, as the operation location, a numerical value “2” indicating the ordinal rank of the added child record. Here, the differential extraction module 11 loads “addition” as the process type and also loads, as the operational data, the information “10000” of the child record, which has been acquired from the network database 21.

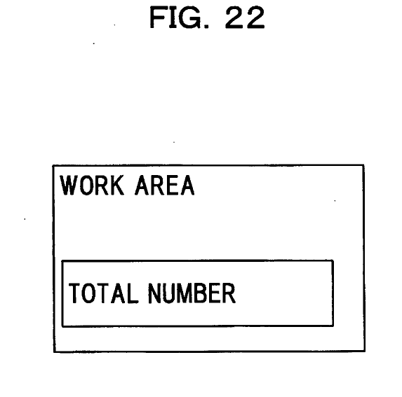

The differential extraction module 11 requests the network database 21 to transmit the total child information number held in the parent record by utilizing the address “X” of the parent record, which is loaded as the parent location. Upon receiving the total child information number “2” from the network database 21, the differential extraction module 11 loads the total child information number “2” in a work area illustrated in FIG. 22. FIG. 22 illustrates the work area in the differential extraction module according to a first embodiment.

The differential extraction module 11 adds 1 to “2” loaded in the work area and loads a resulting new total child information number “3” in association with the process type. Further, the differential extraction module 11 requests the network database 21 to update the total child information number, which is held in the parent record having the address “X”, to the new total child information number “3”. Thereafter, the differential extraction module 11 transmits the process information to the sequence number generation module 13.

The sequence number generation module 13 confirms whether the operation location in the process information received from the differential extraction module 11 is expressed by a numerical value indicating the ordinal rank. In the case illustrated in FIG. 9A, because the information loaded as the operation location and indicating the ordinal rank is the numerical value “2”, the sequence number generation module 13 transmits the process information to the differential reflection module 14, as it may be, without updating the received process information.

The differential reflection module 14 recognizes “addition” loaded as the process type in the received process information and executes the addition process. The differential reflection module 14 first recognizes, based on the total child information number “3” loaded in association with the process type and the ordinal rank “2” loaded as the operation location, the necessity of updating those items of information, which are assigned with “2” or more as numerical values indicating the ordinal ranks, among the data (information) stored in the relational database 15.

The differential reflection module 14 adds 1 to each of the numerical values of “2” or more, which indicate the ordinal ranks, among the data (information) stored in the relational database 15. Thereafter, the differential reflection module 14 causes the information “10000”, which is attached with the numerical value “2” indicating the ordinal rank, to be added to the relational database 15.

The differential reflection module 14 updates the ordinal rank “2” to “3” by using the SQL command “UPDATE”. Further, the differential reflection module 14 adds the information “10000” assigned with the ordinal rank “2” to the relational database 15 by using the SQL command “INSERT”.

When the application program employs an address, as illustrated in FIG. 9B, to designate a location where a child record is to be added, the network database 21 adds the child record at the designated address. The network database 21 notifies the designated address and the added child record to the differential extraction module 11. In the case illustrated in FIG. 9B, the network database 21 adds a child record “10000” at an address “Z”.

By utilizing the information received from the network database 21, the differential extraction module 11 loads “addition” as the process type, “10000” as the operational data, and the address “Z” as the operation location.

Herein, the information received from the network database 21 does not include the address where the parent record is stored. Therefore, the differential extraction module 11 executes a search for the parent record by using the address of the received child record, and acquires the address of the parent record. In the case illustrated in FIG. 9B, the differential extraction module 11 acquires the address “X” of the parent record that is correlated with the added child record.

The differential extraction module 11 loads the address “X” as the parent location in the process information. Further, the differential extraction module 11 receives the total child information number “2” from the parent record loaded at the address “X” and loads, in association with the process type, a value “3” which is resulted from adding 1 to the received total child information number and which becomes a new total child information number.

Further, the differential extraction module 11 requests the network database 21 to update the total child information number held in the parent record, which is loaded at the address “X”, to the new total child information number “3”. The differential extraction module 11 transmits the process information including the respective items of information to the sequence number generation module 13.

The sequence number generation module 13 confirms the information loaded as the operation location in the process information that has been received from the differential extraction module 11. The sequence number generation module 13 acquires the address “Z” loaded as the operation location and searches for the ordinal rank of the child record having the address “Z”.

To that end, by using the address “X” loaded as the parent location, the sequence number generation module 13 searches the network database 21 for the parent record, which is loaded at the address “X”. Further, the sequence number generation module 13 searches for the child record, which is loaded at the address “Z”, while following pointers from the parent record loaded at the address “X”.

The sequence number generation module 13 loads “0” in the work area illustrated in FIG. 21 and searches for the parent record having the address loaded as the parent location. The sequence number generation module 13 adds 1 to the value in the work area and searches for the child record that is indicated by a pointer from the parent record. Here, the sequence number generation module 13 determines whether the address where the child record found by the search is stored is the same as the address loaded as the operation location.

If the address where the child record found by the search is stored is the same as the address loaded as the operation location, the sequence number generation module 13 loads, with respect to the operation location, the value in the work area as a numerical value indicating the ordinal rank of the operated child record. If, the address where the child record found by the search is stored is not the same as the address loaded as the operation location, the sequence number generation module 13 adds 1 to the value in the work area and searches for the next child record that is indicated by a pointer from the current child record.

In the case illustrated in FIG. 9B, the sequence number generation module 13 alters the address “Z” loaded as the operation location to the ordinal rank “2”. Thereafter, the sequence number generation module 13 transmits the altered process information to the differential reflection module 14.

The differential reflection module 14 recognizes “addition” loaded as the process type in the received process information and executes the addition process. The differential reflection module 14 first recognizes, based on the total child information number “3” loaded in association with the process type and the ordinal rank “2” loaded as the operation location, the necessity of updating those items of information, which are assigned with the ordinal ranks of “2” or more, among the data (information) stored in the relational database 15. The differential reflection module 14 adds 1 to each of the numerical values of “2” or more, which indicate the ordinal ranks, among the data (information) stored in the relational database 15. Thereafter, the differential reflection module 14 causes the information including the operational data “10000” and the ordinal rank “2” to be added to the relational database 15.

The differential reflection module 14 prepares SQL and transmits it to the relational database 15. In the case illustrated in FIG. 9B, the differential reflection module 14 updates the ordinal rank “2” to “3” by using the SQL command “UPDATE”. Further, the differential reflection module 14 adds the operational data “10000” assigned with the ordinal rank “2” to the relational database 15 by using the SQL command “INSERT”.

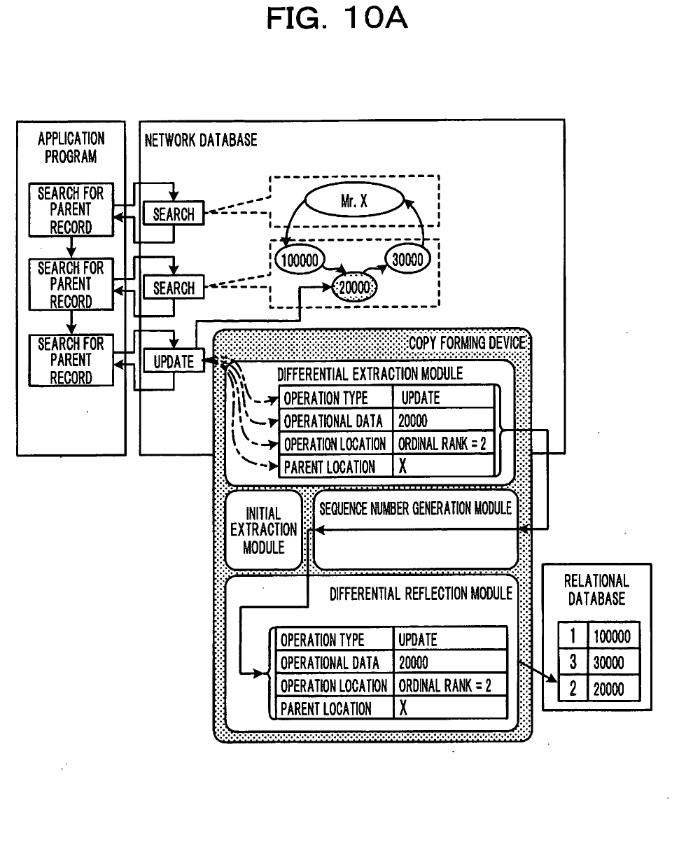

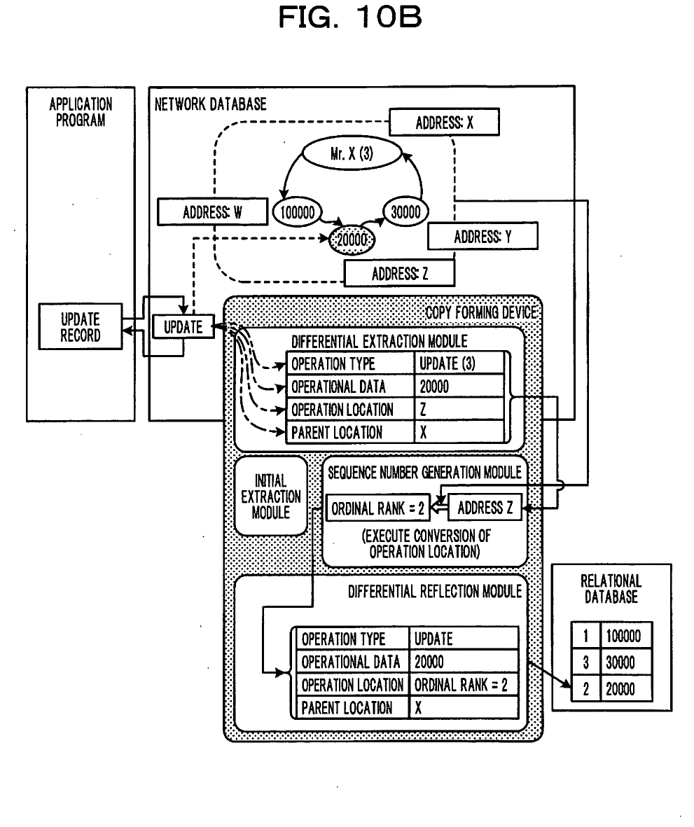

The update process executed in the copy forming device 10 will be described in more detail below with reference to FIGS. 10A and 10B. FIG. 10A illustrates the update process according to a first embodiment. FIG. 10B illustrates the update process according to a first embodiment. In the following, the description of similar processing to that in the addition process is omitted.

Upon receiving the detail of the update process from the network database 21, the differential extraction module 11 forms process information in which “update” is loaded as the process type and “20000” is loaded as the operational data. In the cases illustrated in FIGS. 10A and 10B, as in the addition process, the differential extraction module 11 further loads the address “X” as the parent location. However, when the process type is “update”, the differential extraction module 11 neither loads a value of the total child information number held in the parent record in association with the process type, nor requests the network database 21 to update the total child information number.

Here, in the case illustrated in FIG. 10A, the differential extraction module 11 loads, as the operation location, a numerical value “2” indicating the ordinal rank. On the other hand, in the case illustrated in FIG. 10B, the differential extraction module 11 loads, as the operation location, the address “Z”. The differential extraction module 11 transmits the formed process information to the sequence number generation module 13.

The sequence number generation module 13 confirms whether the operation location in the process information received from the differential extraction module 11 is expressed by a numerical value indicating the ordinal rank. In the case illustrated in FIG. 10A, because the information loaded as the operation location is the ordinal rank “2”, the sequence number generation module 13 transmits the process information to the differential reflection module 14, as it may be, without updating the received process information.

On the other hand, in the case illustrated in FIG. 10B, because the information loaded as the operation location is the address “Z”, the sequence number generation module 13 searches the network database 21 and changes the address “Z”, which is loaded as the operation location, to the ordinal rank “2” as in the case of the addition process. Thereafter, the sequence number generation module 13 transmits the changed process information to the differential reflection module 14.

The differential reflection module 14 recognizes “update” loaded as the process type in the received process information and executes the update process. More specifically, in the cases illustrated in FIGS. 10A and 10B, the differential reflection module 14 updates the operational data “10000” assigned with the ordinal rank “2” to “20000” by using the SQL command “UPDATE”.

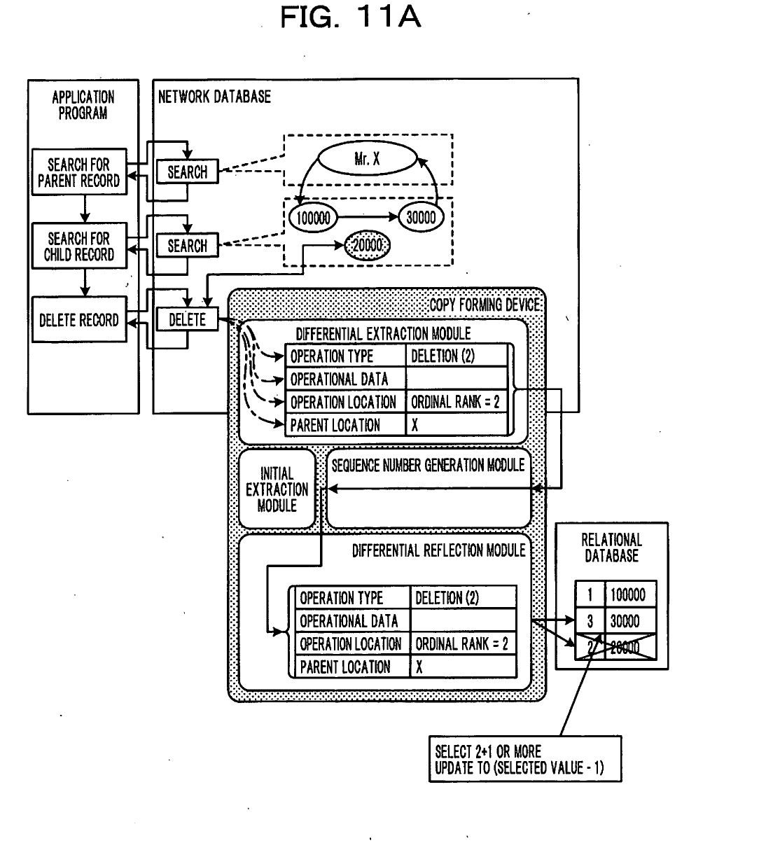

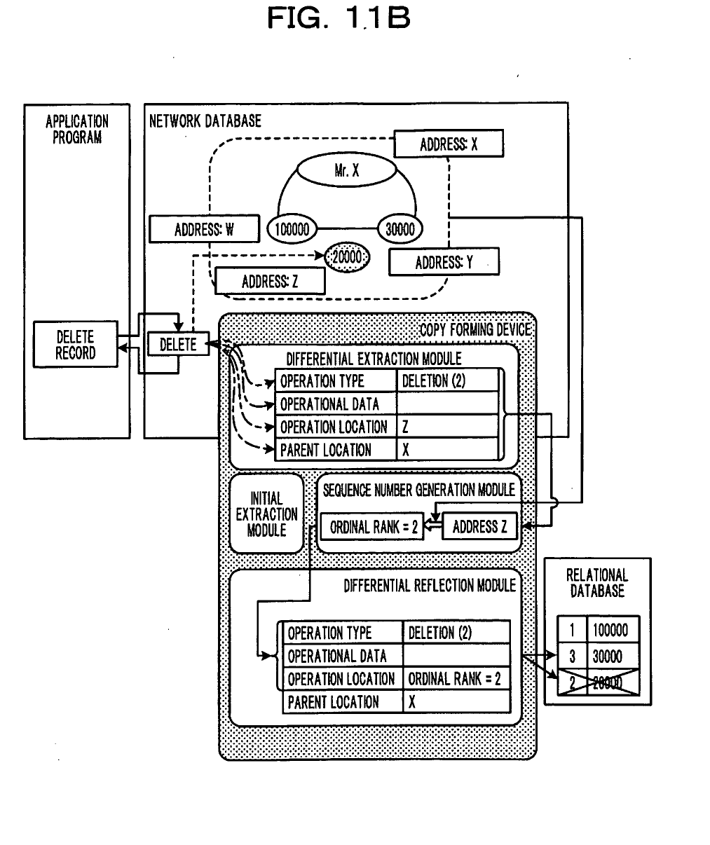

The deletion process executed in the copy forming device 10 will be described in more detail below with reference to FIGS. 11A and 11B. FIG. 11A illustrates the deletion process according to a first embodiment. FIG. 11B illustrates the deletion process according to a first embodiment. In the following, the description of similar processing to that in the addition process is omitted.

Upon acquiring the detail of the deletion process from the network database 21, the differential extraction module 11 forms process information in which “deletion” is loaded as the process type. In the cases illustrated in FIGS. 11A and 11B, as in the addition process, the differential extraction module 11 further loads the address “X” as the parent location.

However, when the process type is “deletion”, the differential extraction module 11 does not store, as the operational data, the detail of the information to be deleted. The differential extraction module 11 loads, in association with the process type, a value “2” which is resulted from subtracting 1 from the total child information number “3” held in the parent record and which becomes a new total child information number. Further, the differential extraction module 11 updates the total child information number “3” held in the parent record to “2”.

Here, in the case illustrated in FIG. 11A, the differential extraction module 11 loads the ordinal rank “2” as the operation location. On the other hand, in the case illustrated in FIG. 11B, the differential extraction module 11 loads the address “Z” as the operation location. The differential extraction module 11 transmits the formed process information to the sequence number generation module 13.

The sequence number generation module 13 confirms whether the operation location in the process information received from the differential extraction module 11 is expressed by a numerical value indicating the ordinal rank. In the case illustrated in FIG. 11A, because the information loaded as the operation location is the numerical value “2”, the sequence number generation module 13 transmits the process information to the differential reflection module 14, as it may be, without updating the received process information.

On the other hand, in the case illustrated in FIG. 11B, because the information loaded as the operation location is the address “Z”, the sequence number generation module 13 searches the network database 21 and changes the address “Z”, which is loaded as the operation location, to the ordinal rank “2”. Thereafter, the sequence number generation module 13 transmits the changed process information to the differential reflection module 14.

The differential reflection module 14 executes the deletion process in accordance with “deletion” loaded as the process type in the received process information. In the cases illustrated in FIGS. 11A and 11B, the differential reflection module 14 recognizes the ordinal rank “2” that is loaded as the operation location. The differential reflection module 14 transmits the SQL command “DELETE” to the relational database 15, thus requesting the relational database 15 to delete the information that is stored with the ordinal rank “2” assigned thereto.

The differential reflection module 14 recognizes, based on the total child information number “2” loaded in association with the process type and the ordinal rank “2” loaded as the operation location, the fact that the ordinal ranks to be updated among the data (information) stored in the relational database 15 are “3” or more. Further, the differential reflection module 14 updates the ordinal rank “3” among the data (information) stored in the relational database 15 to “2” by using the SQL command “UPDATE”.

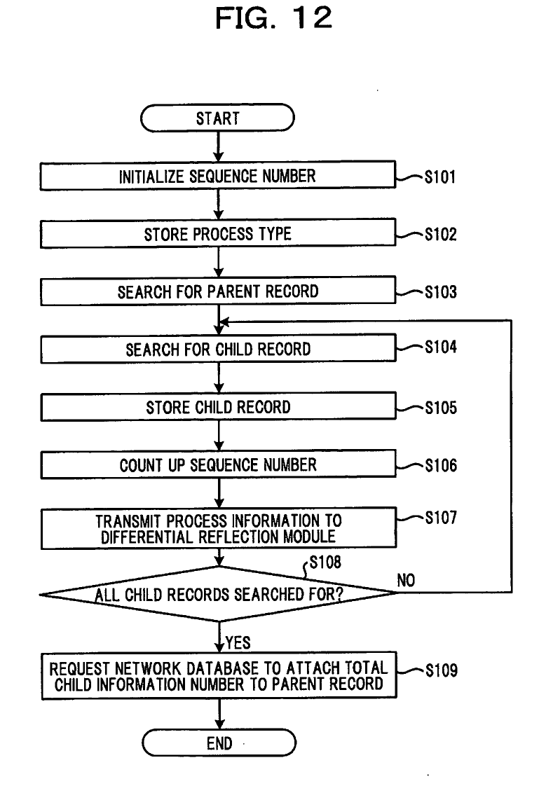

The processing flow of the initial extraction executed by the initial extraction module 12 will be described below with reference to FIG. 12. FIG. 12 illustrates the processing flow of the initial extraction according to a first embodiment.

The initial extraction module 12 executes the initial extraction upon confirming, as a trigger, that the information stored in the network database 21 is not copied into the relational database 15. The initial extraction module 12 sets a sequence number counter to “0” (operation S101) and loads “initial” as the process type (operation S102).

The initial extraction module 12 searches for a parent record (operation S103) and starts a search for a child record correlated with one parent record (operation S104). The initial extraction module 12 searches for the child record indicated by a pointer, which is attached to each preceding record (operation S104), and stores the child record found by the search (operation S105). Whenever the initial extraction module 12 stores the child record (operation S105), it counts up the sequence number of the child record (operation S106). Thereafter, the initial extraction module 12 transmits the process information, including the operation location, the operational data, and the parent location, to the differential reflection module 14 (operation S107).

The initial extraction module 12 determines whether all the child records correlated with the one parent record have been searched for (operation S108). If the child records correlated with the one parent record are not yet completely searched for (NO in operation S108), the initial extraction module 12 executes a search for a next child record indicated by a next pointer (operation S104).

If all the child records correlated with the one parent record have been searched for (YES in operation S108), the initial extraction module 12 requests the network database 21 to attach, as the total child information number, the counted sequence number to the parent record (operation S109). The processing in the initial extraction module 12 is then brought to an end.

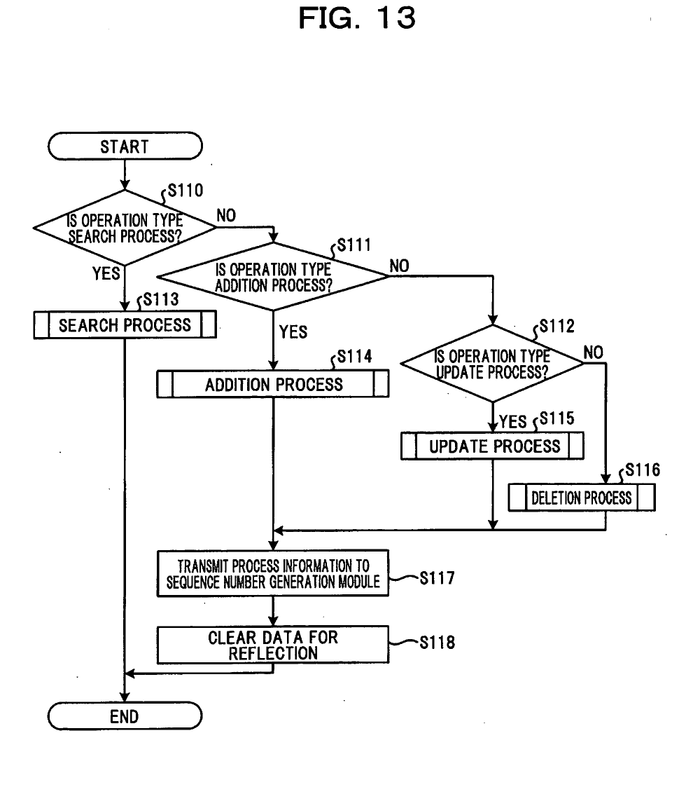

Processing executed by the differential extraction module 11 will be described below with reference to FIG. 13. FIG. 13 illustrates processing executed by the differential extraction module according to a first embodiment. The differential extraction module 11 starts the processing upon confirming, as a trigger, that information of a record as a processing target has been received from the network database 21.

The differential extraction module 11 determines whether the network database 21 is executing the search process (operation S110). If the network database 21 is executing the search process (YES in operation S110), the differential extraction module 11 executes the search process (operation S113), followed by bringing the processing to an end.

If, the network database 21 is not executing the search process (NO in operation S110), the differential extraction module 11 determines whether the network database 21 is executing the addition process (operation S111).

If the network database 21 is executing the addition process (YES in operation S111), the differential extraction module 11 executes the addition process (operation S114) and transmits the process information to the sequence number generation module 13 (operation S117). Thereafter, the differential extraction module 11 erases a cache of the transmitted process information (operation S118) and brings the processing to an end.

If, the network database 21 is not executing the addition process (NO in operation S111), the differential extraction module 11 determines whether the network database 21 is executing the update process (operation S112).

If the network database 21 is executing the update process (YES in operation S112), the differential extraction module 11 executes the update process (operation S115) and transmits the process information to the sequence number generation module 13 (operation S117). Thereafter, the differential extraction module 11 erases a cache of the transmitted process information (operation S118) and brings the processing to an end.

If, the network database 21 is not executing the update process (NO in operation S112), the differential extraction module 11 determines that the network database 21 is executing the deletion process, and executes the deletion process (operation S116). Thereafter, the differential extraction module 11 transmits the process information to the sequence number generation module 13 (operation S117) and erases a cache of the transmitted process information (operation S118), followed by bringing the processing to an end.

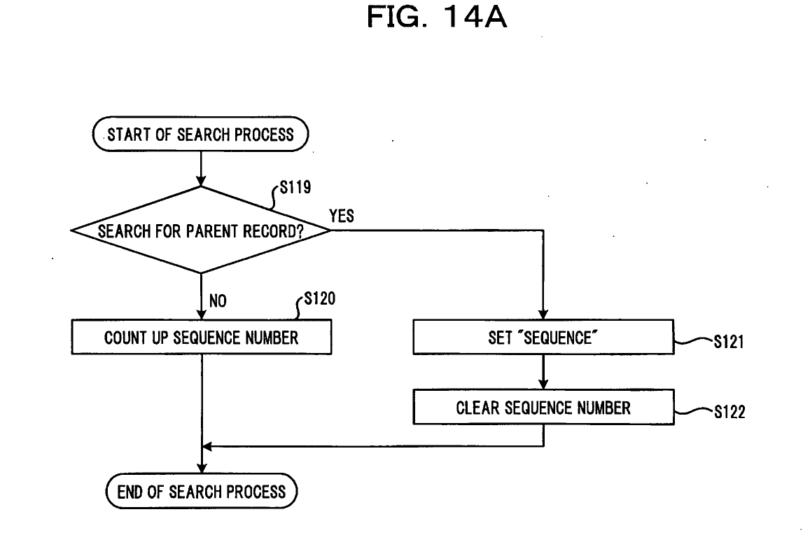

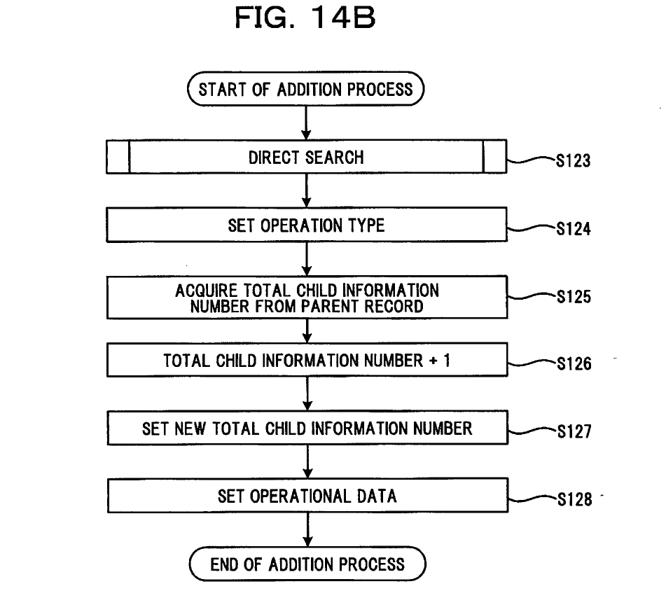

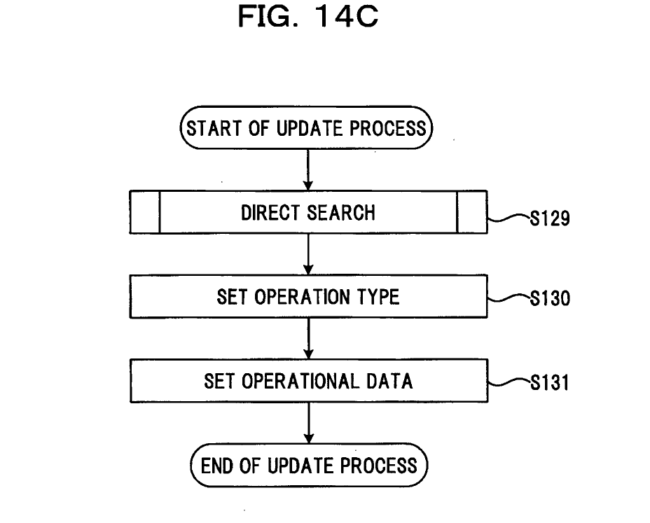

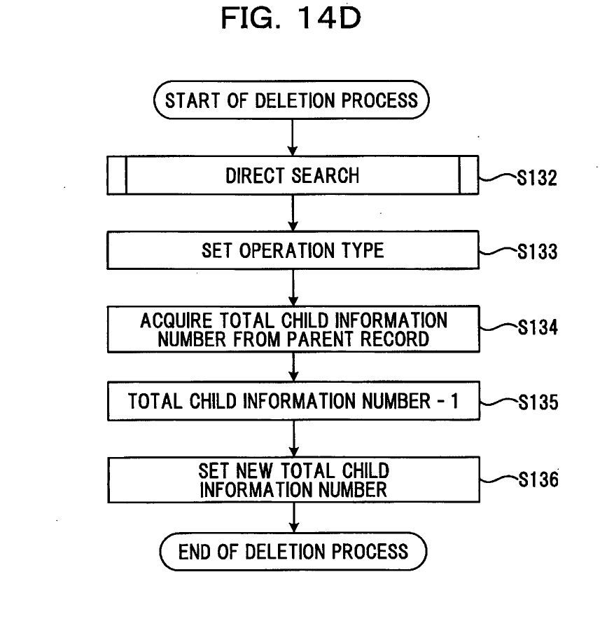

FIG. 14A illustrates the search process executed by the differential extraction module according to a first embodiment.

If the network database 21 is executing the search process (YES in operation S110), the differential extraction module 11 starts the search process (operation S113). The differential extraction module 11 determines whether the network database 21 is searching for a parent record (operation S119).

If the network database 21 is not searching for a parent record (NO in operation S119), may be that the network database 21 is searching for a child record. Therefore, the differential extraction module 11 counts the sequence number of each child record (operation S120). Thereafter, the differential extraction module 11 brings the search process to an end.

If, the network database 21 is searching for a parent record (YES in operation S119), the differential extraction module 11 loads information representing that the operation location in the process information is “sequence” (operation S121) and further loads the sequence number as “0” (operation S122). Thereafter, the differential extraction module 11 brings the search process to an end.

FIG. 14B illustrates the addition process executed by the differential extraction module according to a first embodiment.

If the network database 21 is executing the addition process (YES in operation S111), the differential extraction module 11 starts the addition process (operation S114). The differential extraction module 11 executes a direct search (operation S123).

After the end of the direct search, the differential extraction module 11 loads “addition” as the process type in the process information (operation S124). The differential extraction module 11 acquires the total child information number from the parent record (operation S125) and adds 1 to the acquired total child information number (operation S126).

The differential extraction module 11 requests the network database 21 to update the parent record by setting, as a new total child information number, a value resulting from adding 1 to the total child information number, and loads the new total child information number in association with the process type in the process information (operation S127).

The differential extraction module 11 loads, as the operational data in the process information, the information of the record that is a target of the addition process, the information being acquired from the network database 21 (operation S128). Thereafter, the differential extraction module 11 brings the addition process to an end.

FIG. 14C illustrates the update process executed by the differential extraction module according to a first embodiment.

If the network database 21 is executing the update process (YES in operation S112), the differential extraction module 11 starts the update process (operation S115). The differential extraction module 11 executes a direct search (operation S129). After the end of the direct search, the differential extraction module 11 loads “update” as the operation type in the process information (operation S130).

The differential extraction module 11 loads, as the operational data in the process information, the information of the record that is a target of the update process, the information being acquired from the network database 21 (operation S131). Thereafter, the differential extraction module 11 brings the update process to an end.

FIG. 14D illustrates the deletion process executed by the differential extraction module according to a first embodiment.

If the network database 21 is not executing the update process (NO in operation S112), the differential extraction module 11 starts the deletion process (operation S116). The differential extraction module 11 executes a direct search (operation S132).

After the end of the direct search, the differential extraction module 11 loads “deletion” as the operation type in the process information (operation S133). The differential extraction module 11 acquires the total child information number from the parent record (operation S134) and subtracts 1 from the acquired total child information number (operation S135).

The differential extraction module 11 requests the network database 21 to update the parent record by setting, as a new total child information number, a value resulting from subtracting 1 from the total child information number, and loads the new total child information number in association with the process type in the process information (operation S136). Thereafter, the differential extraction module 11 brings the deletion process to an end.

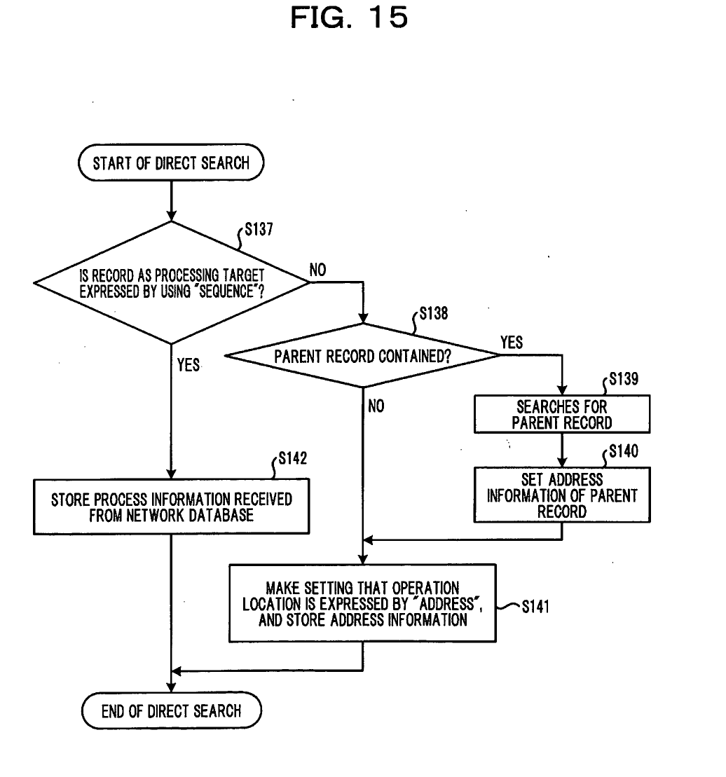

The direct search executed by the differential extraction module 11 will be described below with reference to FIG. 15. The term “direct search” may be defined as a process of determining whether the record as a processing target is designated by an address. If the application program designates the record as the processing target by an address, the differential extraction module 11 does not receive the address of the parent record from the network database 21.

However, when the address designating the record as a processing target is changed to a numerical value indicating the ordinal rank, the copy forming device 10 requires the address designating the parent record. Accordingly, when the record as a processing target is designated by an address, the differential extraction module 11 executes the direct search to search for the parent record that is correlated with the designated child record, thereby acquiring the address where the parent record is stored. FIG. 15 illustrates the direct search executed by the differential extraction module according to a first embodiment.

After starting the direct search, the differential extraction module 11 determines whether the child record as the processing target, which is received from the network database 21, is designated by “sequence” (operation S137). If the child record as the processing target is designated by “sequence” (YES in operation S137), the differential extraction module 11 loads respective items of the process information received from the network database 21 (operation S142).

The differential extraction module 11 makes setting that the information loaded as the operation location is expressed by “sequence”, and loads the “sequence number (ordinal rank)” of the child record as the processing target. Further, the differential extraction module 11 loads the “address” of the parent record as the parent location. Thereafter, the differential extraction module 11 brings the direct search to an end.

If, the child record as the processing target is not designated by “sequence” (NO in operation S137), this may be defined as that the child record acquired from the network database 21 as the processing target is designated by “address”. Accordingly, if the child record as the processing target is not designated by “sequence” (NO in operation S137), the differential extraction module 11 determines whether the address of the parent record is contained in the information acquired from the network database 21 (operation S138).

If the address of the parent record is contained in the acquired information (YES in operation S138), the differential extraction module 11 makes setting that the information loaded as the operation location in the process information is expressed by “address”, and loads the “address” of the child record that is the processing target (operation S141). Further, the differential extraction module 11 loads the “address” of the parent record as the parent location (operation S141). Thereafter, the differential extraction module 11 brings the direct search to an end.

If, the “address” of the parent record is not contained in the acquired information (NO in operation S138), the differential extraction module 11 searches the network database 21 for the parent record by using the “address” of the child record (operation S139). Further, the differential extraction module 11 acquires the “address” of the parent record, which has been found by the search in operation S139, and loads the “address” of the parent record as the parent location in the process information (operation S140).

The differential extraction module 11 makes setting that the information loaded as the operation location in the process information is expressed by “address”, and loads the “address” of the child record that is the processing target (operation S141). Further, the differential extraction module 11 loads the “address” of the parent record as the parent location (operation S141). Thereafter, the differential extraction module 11 brings the direct search to an end.

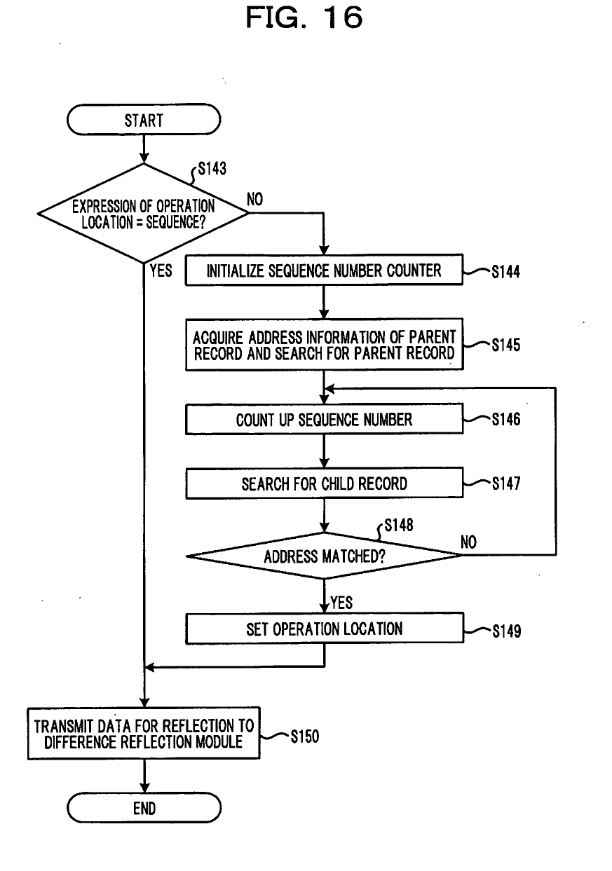

A processing executed by the sequence number generation module 13 will be described with reference to FIG. 16. FIG. 16 illustrates the processing executed by the sequence number generation module according to a first embodiment. The sequence number generation module 13 starts the processing upon confirming, as a trigger, that the process information has been received from the differential extraction module 11.

The sequence number generation module 13 determines whether the information contained in the process information received from the differential extraction module 11 and representing the operation location is expressed by “sequence” (operation S143). If the information representing the operation location is expressed by “sequence” (YES in operation S143), the sequence number generation module 13 transmits the process information acquired from the differential extraction module 11, as it may be, to the differential reflection module 14 (operation S150), followed by bringing the processing to an end.

If, the information representing the operation location is not expressed by “sequence” (NO in operation S143), the sequence number generation module 13 initializes a counter that generates a sequence number (operation S144).

The sequence number generation module 13 loads “0” in the work area illustrated in FIG. 21. The sequence number generation module 13 acquires the “address” of the parent record from the parent location in the process information that has been acquired from the differential extraction module 11, and searches the network database 21 for the parent record having the acquired “address” (operation S145).

The sequence number generation module 13 adds “1” to the numerical value loaded in the work area (operation S146) and searches for the child record (operation S147) indicated by a pointer attached to the parent record that has been found by the search in operation S145.

If the “address” of the child record found by the search in operation S147 matches with the “address” loaded as the operation location in the process information (YES in operation S148), the sequence number generation module 13 makes setting that the information representing the operation location in the process information is expressed by “sequence”, and loads the value set in the work area as the ordinal rank (operation S149). Thereafter, the sequence number generation module 13 transmits the process information, as it may be, to the differential reflection module 14 (operation S150), followed by bringing the processing to an end.

If, the address of the child record found by the search in operation S147 does not match with the address loaded as the operation location (NO in operation S148), the sequence number generation module 13 increments the value of the counter by “1” again (operation S146) and searches for a next child record that is indicated by a next pointer (operation S147).

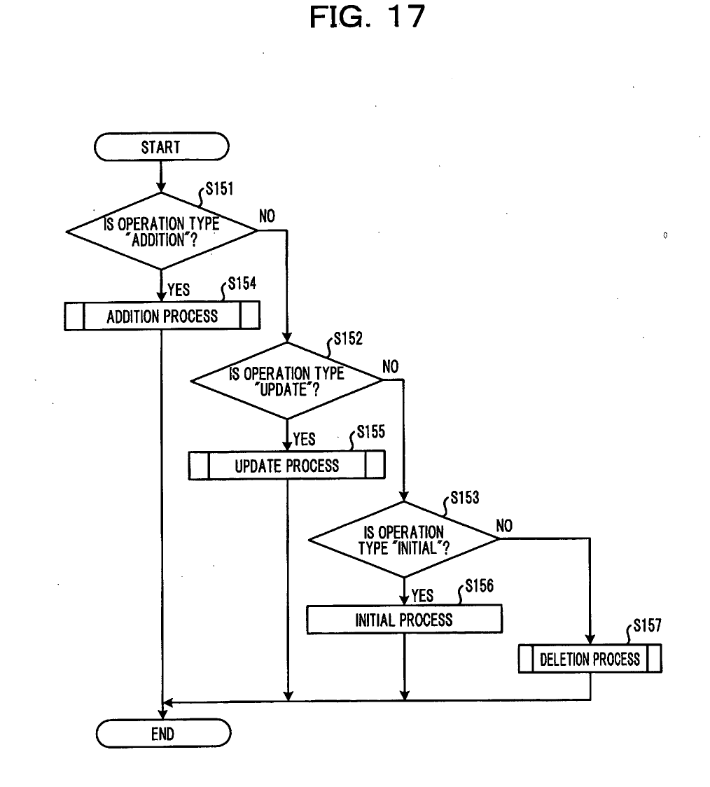

A processing executed by the differential reflection module 14 will be described with reference to FIG. 17. FIG. 17 illustrates the processing executed by the differential reflection module according to a first embodiment. The differential reflection module 14 starts the processing upon confirming, as a trigger, that the process information has been received from the initial extraction module 12 or the differential extraction module 13.

The differential reflection module 14 determines whether the information loaded as the process type in the process information is “addition” (operation S151). If the information loaded as the process type is “addition” (YES in operation S151), the differential reflection module 14 executes the addition process (operation S154), followed by bringing the processing to an end.

If, the information loaded as the process type is not “addition” (NO in operation S151), the differential reflection module 14 determines whether the information loaded as the process type is “update” (operation S152). If the information loaded as the process type is “update” (YES in operation S152), the differential reflection module 14 executes the update process (operation S155), followed by bringing the processing to an end.

If, the information loaded as the process type is not “update” (NO in operation S152), the differential reflection module 14 determines whether the information loaded as the process type is “initial” (operation S153). If the information loaded as the process type is “initial” (YES in operation S153), the differential reflection module 14 forms a copy in the relational database 15 based on the process information (operation S156), followed by bringing the processing to an end.

If, the information loaded as the process type is not “initial” (NO in operation S153), the differential reflection module 14 executes the deletion process (operation S157), followed by bringing the processing to an end.

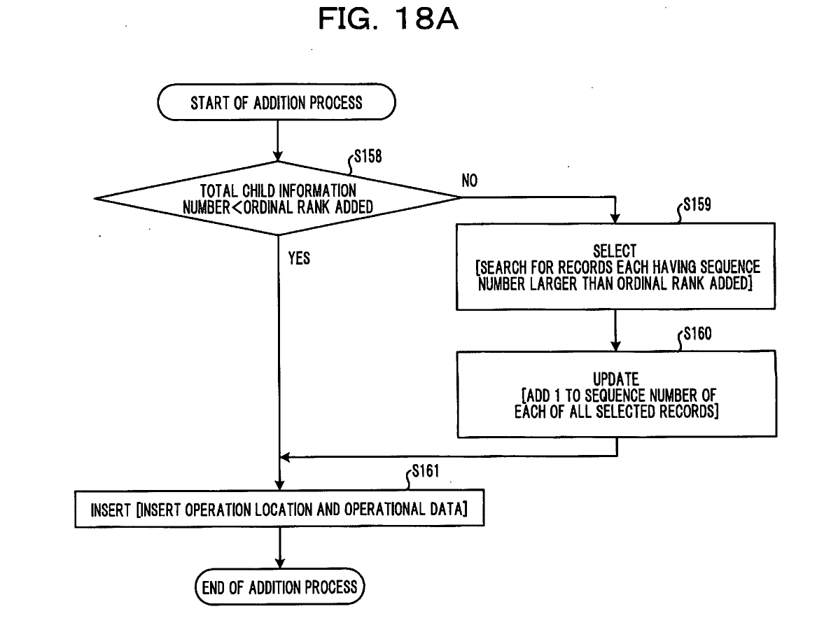

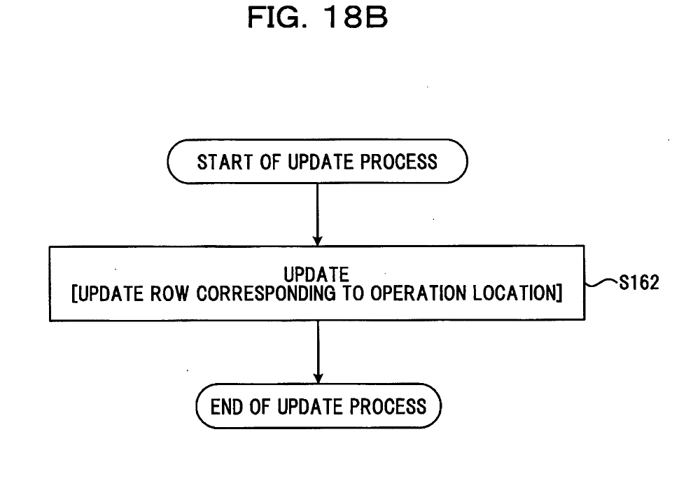

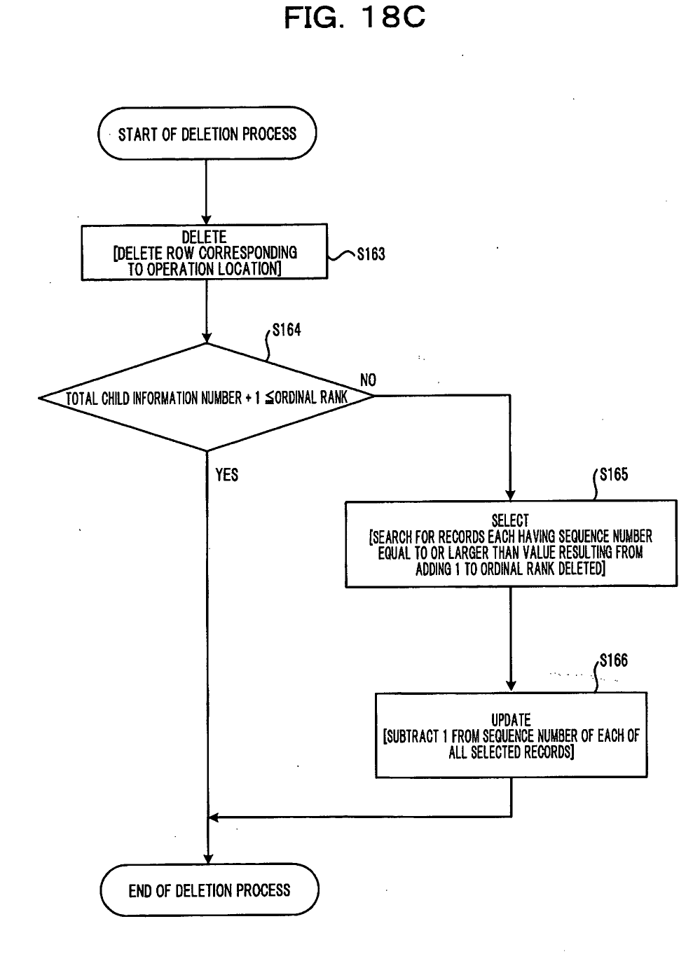

the addition process executed by the differential reflection module 14 will be described below with reference to FIG. 18A. FIG. 18A illustrates the addition process executed by the differential reflection module according to a first embodiment.

If the information loaded as the process type is “addition” (YES in operation S151), the differential reflection module 14 determines whether the numerical value indicating the ordinal rank loaded as the operation location is equal to or lager than the total child information number loaded in association with the process type (operation S158).

If the numerical value indicating the ordinal rank is equal to or lager than the total child information number (YES in operation S158), the differential reflection module 14 inserts the respective items of the process information into the relational database 15 by using the SQL command “INSERT” (operation S161). Thereafter, the differential reflection module 14 brings the addition process to an end.

If, the numerical value indicating the ordinal rank is smaller than the total child information number (NO in operation S158), the differential reflection module 14 selects one or more records, which are assigned with sequence numbers larger than the numerical value indicating the ordinal rank, from the relational database 15 by using the SQL command “SELECT” (operation S159).

The differential reflection module 14 adds 1 to the numerical value indicating the ordinal rank of each record, which has been selected in operation S159, by using the SQL command “UPDATE” (operation S160). Further, the differential reflection module 14 inserts the respective items of the process information into the relational database 15 by using the SQL command “INSERT” (operation S161). Thereafter, the differential reflection module 14 brings the addition process to an end.

An update process executed by the differential reflection module 14 will be described below with reference to FIG. 18B. FIG. 18B illustrates the update process executed by the differential reflection module according to a first embodiment.

If the information loaded as the process type is “update” (YES in operation S152), the differential reflection module 14 reflects the respective items of the process information upon the relational database 15 by using the SQL command “UPDATE” (operation S162). Thereafter, the differential reflection module 14 brings the update process to an end.

FIG. 18C illustrates the deletion process executed by the differential reflection module according to a first embodiment.

If the information loaded as the process type is not “initial” (NO in operation S153), the differential reflection module 14 reflects the process information upon the relational database 15 for deletion of data by using the SQL command “DELETE” (operation S163).

The differential reflection module 14 determines whether the numerical value loaded as the operation location and indicating the ordinal rank is equal to or lager than a value resulting from adding 1 to the total child information number that is loaded in association with the process type (operation S614). If the numerical value indicating the ordinal rank is equal to or lager than the value resulting from adding 1 to the total child information number (YES in operation S614), the differential reflection module 14 brings the deletion process to an end.

If, the numerical value indicating the ordinal rank is smaller than the value resulting from adding 1 to the total child information number (NO in operation S614), the differential reflection module 14 selects one or more records, which are assigned with sequence numbers larger than the numerical value indicating the ordinal rank, from the relational database 15 (operation S165). The differential reflection module 14 selects one or more records, which are assigned with sequence numbers larger than the numerical value indicating the ordinal rank, from the relational database 15 by using the SQL command “SELECT”.

The differential reflection module 14 subtracts 1 from the numerical value indicating the ordinal rank of each record, which has been selected in operation S165, by using the SQL command “UPDATE” (operation S166). Thereafter, the differential reflection module 14 brings the deletion process to an end.

When any of various alterations is made on the information at the copy source, the copy forming device 10 according to a first embodiment can reflect only the differential upon the copy destination while maintaining the original sequence of the stored information. Therefore, the copy forming device 10 can minimize consumption of the server resources.

Further, the copy forming device 10 can minimize corrections to be made on the information at the copy source without requiring intricate corrections of the application program that requests the network database 21, i.e., the copy source, to execute the various processes. From that point of view, too, the copy forming device 10 can minimize consumption of the server resources.

Still further, when the application program designates the child record, which becomes a target of any of the various processes, by using an address, the copy forming device 10 according to a first embodiment searches for the child record having the designated address in the order of pointers, and acquires the ordinal rank of the child record having the designated address.

Accordingly, the copy forming device 10 can acquire the ordinal rank of the child record, which becomes a target of any of the various processes, regardless of the method by which the application program designates the child record as the target of any of the various processes. As a result, the copy forming device 10 can minimize consumption of the server resources without requiring intricate corrections of the application program.

Moreover, the copy forming device 10 according to a first embodiment assigns, to the parent record stored in the network database 21, the number of child records correlated with the relevant parent record as the total child information number. Also, when any alternation process is executed on the child record stored in the network database 21, the copy forming device 10 can select the information to be updated from among the data (information) stored in the relational database 15 by using the total child information number.

Consequently, when the relational database 15 is updated, the copy forming device 10 can execute the update process without executing any extra search process on the relational database 15. Hence, the copy forming device 10 can minimize consumption of server resources.

Another exemplary embodiment is disclosed.

In the copy forming device according to a first embodiment, the numerical value indicating the ordinal rank of the child data (record) or the address of the child data (record), which has become a target of any of the various processes, is loaded as the operation location in the process information. However, embodiments of the present invention are not limited to a first embodiment, and other one or more items of information may be additionally loaded.

It may be just required that the ordinal rank of the child data (record), which has become a target of any of the various processes, can be specified by using the information loaded as the operation location in the process information. For example, when the network database is a network database including a plurality of HDDs (Hard Disk Drives), in which one of the HDDs the relevant child record is loaded, with which parent record the relevant child record is correlated, and what ordinal rank is assigned to the relevant child record may be loaded as information representing the operation location.

Further, in the copy forming device according to a first embodiment, the address of the parent record is loaded as the parent location in the process information. However, embodiments of the present invention are not limited to a first embodiment. For example, some other suitable information loaded in the parent record may be loaded as the parent location. The reason is that so long as unique information is loaded in each parent record, it may be possible to select a table, which becomes a target of any of the various processes, from copies stored in the RDB.

In a first embodiment, the differential extraction module 11 is included in the copy forming device 10, but it may be installed in some other suitable place. When the network database as the copy source and the relational database as the copy destination are located physically far away from each other, the copy forming device can operate with higher copying efficiency by installing the differential extraction module in the network database. The copy forming device may be arranged, for example, such that the differential extraction module is installed near the network database as the copy source, other portions of the copy forming device are installed near the relational database as the copy destination, and the differential extraction module and the other portions are interconnected via a network.

The reason is that the copy forming device can achieve its desired performance if the differential between the network database and the relational database can be just reflected upon the information stored in the relational database while maintaining the sequence relations among the data (information) stored in the network database.

In the copy forming device according to a first embodiment, the information in the network database is copied into the relational database by using the initial extraction module. However, embodiments of the present invention are not limited to a first embodiment, and an aspect of the present invention can also be achieved, for example, without using the initial extraction module.

For example, when the RDB is previously constructed as a copy of the NDB, the copy forming device can reflect the differential by using the differential extraction module, the sequence number generation module, and the differential reflection module without requiring the initial extraction module.

While the copy forming device according to a first embodiment has been described above in connection with the case of realizing the various processes by utilizing hardware, the present invention is not limited to that case. As an alternative, the various processes may be realized by executing previously prepared programs on a computer.

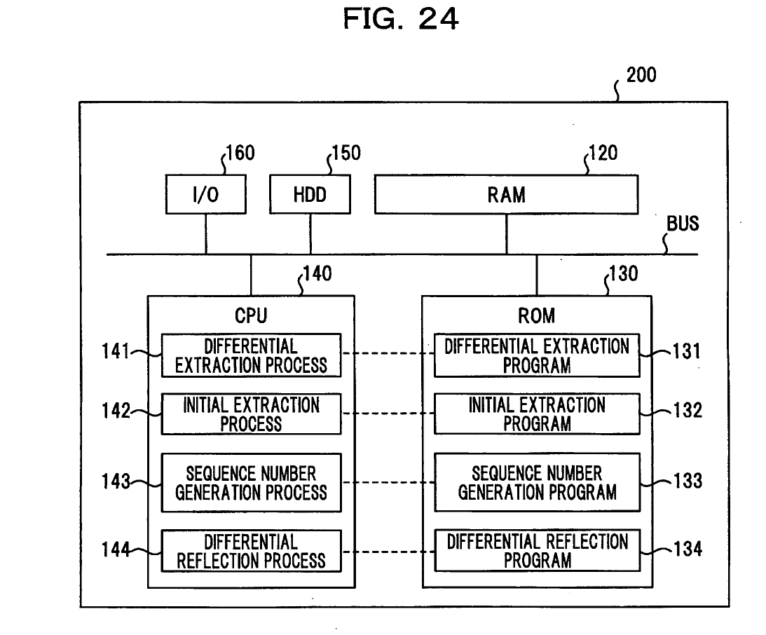

A computer 200 illustrated in FIG. 24 includes an HDD 150, a RAM (Random Access Memory) 120, a ROM (Read Only Memory) 130, and a CPU (Central Processing Unit) 140, which are interconnected via a bus 170. Further connected to the bus 170 is a connection terminal I/O (Input/Output) 160 for connection to the network database 21 and the relational database 15.

A differential extraction program 131, an initial extraction program 132, a sequence number generation program 133, and a differential reflection program 134 are previously held in the ROM 130. With the CPU 140 reading the programs 131 to 134 from the ROM 130 and executing those programs, the programs 131 to 134 function respectively as a differential extraction process 141, an initial extraction process 142, a sequence number generation process 143, and a differential reflection process 144, as illustrated in FIG. 24.

The processes 141 to 144 correspond respectively to the differential extraction module 11, the initial extraction module 12, the sequence number generation module 13, and the differential reflection module 14, which are illustrated in FIG. 1.

The programs 131 to 134 are not always required to be held in the ROM 130. For example, the programs 131 to 134 may be recorded in the HDD 150 and developed by the CPU 140 so as to function as the processes 141 to 144, respectively. As an alternative, the programs 131 to 134 may be held in the RAM 120.

The copy forming programs described above in the embodiment can be realized by preparing the programs in advance and executing the programs on a personal computer or a computer in a workstation, etc. The programs can be distributed via a network, such as the Internet.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it may be not desired to limit the inventive embodiments to the exact construction and operation illustrated and described, and accordingly all suitable modifications and equivalents may be resorted to, falling within the scope thereof.

What is claimed is:

1. A recording medium recording an information copying program, the information copying program causing a computer to execute:
a sequence information computation procedure of, when an alteration process is executed on information stored at a copy source storing plural items of information, computing sequence information representing an ordinal rank of the altered information within records, which are stored at the copy source, by using information representing an altered location with respect to the records; and
a copy destination reflection procedure of reflecting the alteration process upon information at a copy destination corresponding to the sequence information computed in the sequence information computation procedure.

2. The recording medium recording the information copying program according to claim 1, wherein when an alteration process of searching for a record as an alteration target while tracking an adjacent one among the records successively starting from a predetermined record is executed, the sequence information computation procedure computes the sequence information representing the ordinal rank of the altered information within the records, which are stored at the copy source, by employing the number of records which is counted from the predetermined record until the record as the alteration target is found by the search.

3. The recording medium recording the information copying program according to claim 1, wherein when an alteration process is executed by using address information specifying a position within the copy destination at which a record as an alteration target is stored, the sequence information computation procedure computes the sequence information representing the ordinal rank of the altered information within the records, which are stored at the copy source, by searching for the record as the alteration target based on the address information, and by employing the number of records which is counted from the predetermined record to the record found by the search as the alteration target.

4. The recording medium recording the information copying program according to claim 1, wherein when new information is added as the alteration process to the information stored in a memory at the copy source, the sequence information computation procedure computes the sequence information of the added information, and
wherein the copy destination reflection procedure reflects the alteration process upon the sequence information at the copy destination such that each sequence number subsequent to the ordinal rank represented by the sequence information, which has been computed in the sequence information computation procedure, is increased, and that the information having been added to the copy source is added to the copy destination together with the reflected sequence information.

5. The recording medium recording the information copying program according to claim 1, wherein when the information stored in a memory at the copy source is deleted as the alteration process, the sequence information computation procedure computes the sequence information of the deleted information, and
wherein the copy destination reflection procedure reflects the alteration process upon the sequence information at the copy destination such that the information having been deleted from the copy source is deleted from the copy destination together with the sequence information, and that each sequence number subsequent to the ordinal rank represented by the sequence information, which has been computed in the sequence information computation procedure, is decreased.

6. The recording medium recording the information copying program according to claim 1, wherein when the information stored in a memory at the copy source is updated as the alteration process, the sequence information computation procedure computes the sequence information of the updated information, and
wherein the copy destination reflection procedure reflects a substance of the update upon information at the copy destination corresponding to the ordinal rank represented by the sequence information, which has been computed in the sequence information computation procedure, is decreased.

7. An information copying device comprising:
a processor, when an alteration process is executed on information stored at a copy source storing plural items of information, to compute sequence information representing an ordinal rank of the altered information within records, which are stored at the copy source, by using information representing an altered location with respect to the records and reflects the alteration process upon information at a copy destination corresponding to the sequence information computed.

8. The information copying device according to claim 7, wherein when an alteration process of searching for a record as an alteration target while tracking an adjacent one among the records successively starting from a predetermined record is executed, the processor computes the sequence information representing the ordinal rank of the altered information within the records, which are stored at the copy source, by employing the number of records which is counted from the predetermined record until the record as the alteration target is found by the search.

9. The information copying device according to claim 7, wherein when an alteration process is executed by using address information specifying a position within the copy destination at which a record as an alteration target is stored, the processor computes the sequence information representing the ordinal rank of the altered information within the records, which are stored at the copy source, by searching for the record as the alteration target based on the address information, and by employing the number of records which is counted from the predetermined record to the record found by the search as the alteration target.

10. The information copying device according to claim 7, wherein when new information is added as the alteration process to the information stored in a memory at the copy source, the processor computes the sequence information of the added information, and
wherein the processor reflects the alteration process upon the sequence information at the copy destination such that each sequence number subsequent to the ordinal rank represented by the sequence information, which has been computed, is increased, and that the information having been added to the copy source is added to the copy destination together with the reflected sequence information.

11. The information copying device according to claim 7, wherein when the information stored in a memory at the copy source is deleted as the alteration process, the processor computes the sequence information of the deleted information, and
wherein the processor reflects the alteration process upon the sequence information at the copy destination such that the information having been deleted from the copy source is deleted from the copy destination together with the sequence information, and that each sequence number subsequent to the ordinal rank represented by the sequence information, which has been computed is decreased.

12. The information copying device according to claim 7, wherein when the information stored in a memory at the copy source is updated as the alteration process, the processor computes the sequence information of the updated information, and
wherein the processor reflects a substance of the update upon information at the copy destination corresponding to the ordinal rank represented by the sequence information, which has been computed is decreased.

13. An information copying method comprising:
when an alteration process is executed on information stored at a copy source storing plural items of information, computing sequence information representing an ordinal rank of the altered information within records, which are stored at the copy source, by using information representing an altered location with respect to the records; and
reflecting the alteration process upon information at a copy destination corresponding to the sequence information computed.

14. The information copying method according to claim 13, wherein when an alteration process of searching for a record as an alteration target while tracking an adjacent one among the records successively starting from a predetermined record is executed, computing the sequence information representing the ordinal rank of the altered information within the records, which are stored at the copy source, by employing the number of records which is counted from the predetermined record until the record as the alteration target is found by the search.

15. The information copying method according to claim 13, wherein when an alteration process is executed by using address information specifying a position within the copy destination at which a record as an alteration target is stored, computing the sequence information representing the ordinal rank of the altered information within the records, which are stored at the copy source, by searching for the record as the alteration target based on the address information, and by employing the number of records which is counted from the predetermined record to the record found by the search as the alteration target.

16. The information copying method according to claim 13, wherein when new information is added as the alteration process to the information stored in a memory at the copy source, computing the sequence information of the added information, and
wherein the reflecting the alteration process upon the sequence information at the copy destination such that each sequence number subsequent to the ordinal rank represented by the sequence information is increased, and that the information having been added to the copy source is added to the copy destination together with the reflected sequence information.

17. The information copying method according to claim 13, wherein when the information stored in a memory at the copy source is deleted as the alteration process, computing the sequence information of the deleted information, and
wherein the reflecting the alteration process upon the sequence information at the copy destination such that the information having been deleted from the copy source is deleted from the copy destination together with the sequence information, and that each sequence number subsequent to the ordinal rank represented by the sequence information, which has been computed in the sequence information computation operation, is decreased.

18. The information copying method according to claim 13, wherein when the information stored in a memory at the copy source is updated as the alteration process, computing the sequence information of the updated information, and
wherein the reflecting a substance of the update upon information at the copy destination corresponding to the ordinal rank represented by the sequence information is decreased.

19. A method of copying comprising:
computing sequence information representing an ordinal rank of altered information within records by using information representing an altered location with respect to the records; and
reflecting the alteration process upon information at a copy destination corresponding to the computed sequence information.
